(19) United States
(12) Patent Application Publication
(10) Pub. No.: US 2021/0349887 A1
(43) Pub. Date: Nov. 11, 2021

(54) SYSTEM AND METHOD FOR AUTOMATICALLY SUGGESTING REMOTE QUERY PARAMETERS BASED FOR CUSTOMIZED DATA INTEGRATION PROCESS

(71) Applicant: BOOMI, INC., Round Rock, TX (US)

(72) Inventors: Joel Alonzo, Raleigh, NC (US); Anil K. Enumulapally, Malvern, PA (US); Rohan J. Jain Alias Jogatar, King of Prussia, PA (US)

(73) Assignee: BOOMI, INC., Round Rock, TX (US)

(21) Appl. No.: 16/869,553

(22) Filed: May 7, 2020

(51) Int. Cl. G06F 16/242; G06F 16/28

(52) U.S. Cl. CPC G06F 16/243; G06F 16/284

(57) ABSTRACT

An information handling system operating an automated data set query suggestion system may comprise a processor executing code instructions for identifying a data set through an API query, a GUI receiving a user-selected query object, and the processor generating a natural language sentence describing a suggested API query, based on node and edge values for a previously executed query database describing previously executed API queries. The suggested API query may have include a suggested query object, a suggested query operator, or a suggested API to be queried, associated in the previously executed query database with the user-selected query object. The GUI may receive a user instruction to perform the suggested API query, the processor may automatically generate a set of code instructions for future execution of the suggested API query, and a network interface device may transmit the code instructions for future execution by a runtime engine for execution at a remote location.

### FIELD OF THE DISCLOSURE

The present disclosure relates generally to a system and method for deploying and executing customized data integration processes. More specifically, the present disclosure relates to suggesting previously executed software or database queries in natural language, for user selection to include within a current search query.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

For purposes of this disclosure, an information handling system may include any instrumentality or aggregate of instrumentalities operable to compute, calculate, determine, classify, process, transmit, receive, retrieve, originate, switch, store, display, communicate, manifest, detect, record, reproduce, handle, or utilize any form of information, intelligence, or data for business, scientific, control, or other purposes. For example, an information handling system may be a personal computer (e.g., desktop or laptop), tablet computer, mobile device (e.g., personal digital assistant (PDA) or smart phone), a head-mounted display device, server (e.g., blade server or rack server), a network storage device, a network storage device, a switch router or other network communication device, other consumer electronic devices, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, touchscreen and/or a video display. The information handling system may also include one or more buses operable to transmit communications between the various hardware components. Further, the information handling system may include telecommunication, network communication, and video communication capabilities and require communication among a variety of data formats.

### BRIEF DESCRIPTION OF THE DRAWINGS

The present disclosure will now be described by way of example with reference to the following drawings in which:

FIG. 1 is a block diagram illustrating an information handling system according to an embodiment of the present disclosure;

FIG. 2 is a block diagram illustrating a simplified integration network according to an embodiment of the present disclosure;

FIG. 3A is a graphical diagram illustrating an automated data set query suggestion system according to an embodiment of the present disclosure;

FIG. 3B is a graphical diagram illustrating an integration application management system according to an embodiment of the present disclosure;

FIG. 4 is a graphical diagram illustrating a user-generated flow diagram of an integration process according to an embodiment of the present disclosure;

FIG. 5 is a graphical diagram illustrating a dataset query selection user interface according to an embodiment of the present disclosure;

FIG. 6A is a graphical diagram illustrating relational database tables storing identification of users who have previously executed queries according to an embodiment of the present disclosure;

FIG. 6B is a graphical diagram illustrating relational database tables storing query objects identified within previously executed query parameter sets according to an embodiment of the present disclosure;

FIG. 6C is a graphical diagram illustrating relational database tables storing query operators identified within previously executed query parameter sets according to an embodiment of the present disclosure;

FIG. 7 is a graphical diagram illustrating a non-relational database according to an embodiment of the present disclosure;

FIG. 8 is a flow diagram illustrating a method of identifying query parameter sets within code instructions of a previously executed remote query according to an embodiment of the present disclosure; and

FIG. 9 is a flow diagram illustrating a method of generating code instructions for an application query based on user selection of a natural language sentence describing the query according to an embodiment of the present disclosure.

The use of the same reference symbols in different drawings may indicate similar or identical items.

### DETAILED DESCRIPTION

The following description in combination with the Figures is provided to assist in understanding the teachings disclosed herein. The description is focused on specific implementations and embodiments of the teachings, and is provided to assist in describing the teachings. This focus should not be interpreted as a limitation on the scope or applicability of the teachings.

Conventional software development and distribution models have involved development of an executable software application, and distribution of a computer-readable medium, or distribution via download of the application from the worldwide web to an end user. Upon receipt of the downloaded application, the end user executes installation files to install the executable software application on the user's personal computer (PC), or other information handling system. When the software is initially executed, the application may be further configured/customized to recognize or accept input relating to aspects of the user's PC, network, etc., to provide a software application that is customized for a particular user's computing system. This simple, traditional approach has been used in a variety of contexts, with software for performing a broad range of different functionality. While this model might sometimes be satisfactory for individual end users, it is undesirable in sophisticated computing environments.

Today, most corporations or other enterprises have sophisticated computing systems that are used both for internal operations, and for communicating outside the enterprise's network. Much of present day information exchange is conducted electronically, via communications networks, both internally to the enterprise, and among enterprises. Accordingly, it is often desirable or necessary to exchange information/data between distinctly different computing systems, computer networks, software applications, etc. In many instances, these disparate computing networks, enterprises, or systems are located in a variety of different countries around the world. The enabling of communications between diverse systems/networks/applications in connection with the conducting of business processes is often referred to as “business process integration.” In the business process integration context, there is a significant need to communicate between different software applications/systems within a single computing network, e.g. between an enterprise's information warehouse management system and the same enterprise's purchase order processing system. There is also a significant need to communicate between different software applications/systems within different computing networks, e.g. between a buyer's purchase order processing system, and a seller's invoicing system. Some of these different software applications/systems may be cloud-based, with physical servers located in several different countries, cities, or other geographical locations around the world. As data is integrated between and among these cloud-based platforms, data sets may be stored (e.g., temporarily or indefinitely) in some form at physical servers in these various geographical locations.

Relatively recently, systems have been established to enable exchange of data via the Internet, e.g. via web-based interfaces for business-to-business and business-to-consumer transactions. For example, a buyer may operate a PC to connect to a seller's website to provide manual data input to a web interface of the seller's computing system, or in higher volume environments, a buyer may use an executable software application known as EDI Software, or Business-to-Business Integration Software to connect to the seller's computing system and to deliver electronically a business “document,” such as a purchase order, without requiring human intervention to manually enter the data. Such software applications are available in the market today. These applications are typically purchased from software vendors and installed on a computerized system owned and maintained by the business, in this example, the buyer. The seller will have a similar/complementary software application on its system, so that the information exchange may be completely automated in both directions. In contrast to the present disclosure, these applications are purchased, installed and operated on the user's local system. Thus, the user typically owns and maintains its own copy of the system, and configures the application locally to connect with its trading partners.

In both the traditional and more recent approaches, the executable software application is universal or “generic” as to all trading partners before it is received and installed within a specific enterprise's computing network. In other words, it is delivered to different users/systems in identical, generic form. The software application is then installed within a specific enterprise's computing network (which may include data centers, etc., physically located outside of an enterprises' physical boundaries). After the generic application is installed, it is then configured and customized for a specific trading partner after which it is ready for execution to exchange data between the specific trading partner and the enterprise. For example, Walmart® may provide on its website specifications of how electronic data such as Purchase Orders and Invoices must be formatted for electronic data communication with Walmart, and how that data should be communicated with Walmart®. A supplier/enterprise is then responsible for finding a generic, commercially available software product that will comply with these communication requirements and configuring it appropriately. Accordingly, the software application will not be customized for any specific supplier until after that supplier downloads the software application to its computing network and configures the software application for the specific supplier's computing network, etc. Alternatively, the supplier may engage computer programmers to create a customized software application to meet these requirements, which is often exceptionally time-consuming and expensive.

Recently, systems and software applications have been established to provide a system and method for on-demand creation of customized software applications in which the customization occurs outside of an enterprise's computing network. These software applications are customized for a specific enterprise before they arrive within the enterprise's computing network, and are delivered to the destination network in customized form. The Dell Boomi® Application is an example of one such software application. With Dell Boomi® and other similar applications, an employee within an enterprise can connect to a website using a specially configured integration process flow modeling user interface to visually model a business integration process via a flowcharting process, using only a web browser interface. During such a modeling process, the user would select from a predetermined set of process-representing visual elements that are stored on a remote server, such as the web server. By way of an example, the integration process could enable a bi-directional exchange of data between internal applications of an enterprise, between internal enterprise applications and external trading partners, or between internal enterprise applications and applications running external to the enterprise.

A customized data integration software application creation system in an embodiment may allow a user to create a customized data integration software application by modeling a data integration process flow using a graphical user interface. A modeled data integration process flow in embodiments of the present disclosure may model actions taken on data elements pursuant to executable code instructions without displaying the code instructions themselves. In such a way, the graphical user interface may allow a user to understand the high-level summary of what executable code instructions achieve, without having to read or understand the code instructions themselves. Similarly, by allowing a user to insert visual elements representing portions of an integration process into the modeled data integration process flow displayed on the graphical user interface, embodiments of the present disclosure allow a user to identify what she wants executable code instructions to achieve without having to write such executable code instructions.

Once a user has chosen what she wants an executable code instruction to achieve in embodiments herein, the code instructions capable of achieving such a task may be generated. Code instructions for achieving a task can be written in any number of languages and/or adhere to any number of standards, often requiring a code writer to have extensive knowledge of computer science and languages. The advent of open-standard formats for writing code instructions that are both human-readable and machine executable have made the writing of code instructions accessible to individuals that do not have a high level knowledge of computer science. Such open-standard, human-readable, data structure formats include extensible markup language (XML) and JavaScript Object Notification (JSON). Because code instructions adhering to these open-standard formats are more easily understood by non-specialists, many companies have moved to the use of code instructions adhering to these formats in constructing their data repository structures and controlling the ways in which data in these repositories may be accessed by both internal and external agents. In order to execute code instructions for accessing data at such a repository during a business integration process, the code instructions of the business integration process in some embodiments herein may be written in accordance with the same open-standard formats or other known, or later-developed standard formats.

In addition to the advent of open-standard, human-readable, machine-executable code instructions, the advent of application programming interfaces (APIs) designed using such open-standard code instructions or proprietary schemas have also streamlined the methods of communication between various software components. An API may operate to communicate with a backend application to identify an action to be taken on a data set that the backend application manages, or which is being transmitted for management to the backend application. Such an action and convention for identifying the data set or its location may vary among APIs and their backend applications. For example, data sets may be modeled according to user-supplied or proprietary definitions. Each data set may contain a user-defined or proprietary data set field name, which may describe a type of information. Each user-defined or proprietary data set field name may be associated with a data set field value. In other words, data sets may be modeled using a fieldname:value pairing. For example, a given API data set model for a customer named John Smith may include a first data set field name “f_name” paired with a first data set field value “John,” and a second data set field name “l_name” paired with a second data set field value “Smith.” A user or an API in an embodiment may define any number of such data set field name/value pairs to describe data sets. Other example data set field names in embodiments may include “dob” to describe date of birth, “ssn” to describe social security number, “phone” to describe a phone number, or “hair,” “race,” and “reward.”

In embodiments described herein, multiple APIs, databases, or backend applications accessed via a single integration process may operate according to differing coding languages, data set structures, data set field naming conventions or standards. Different coding languages may use different ways of describing routines, data structures, object classes, variables, or remote calls that may be invoked and/or handled during business integration processes that involve data set field values managed by databases or by the backend applications such APIs serve. For example, in comparison to the API referenced directly above storing a fieldname/value of “f_name”/“John,” a data set for the same customer in a separate API may use a first data set field name “FirstName.” Thus, a single data set field value (e.g., “John”) may be described in a single integration process using a plurality of data set field names (e.g., “f_name” or “FirstName”), each adhering to the naming conventions set by databases, the APIs, applications, enterprises, or trading partners through or among which the data set field value is programmed to integrate.

A user interacting with such a database, or an API for a backend application may identify such data set field values based on a description that may or may not include the actual data set field name of the data set field value. In some circumstances, a data set field value may be identified through a search or query mechanism, or through navigation through a variety of menus, for example. For example, a user in an embodiment may execute a direct query of a database or an application to identify one or more data sets managed by the database or application. In such an embodiment, the query executed by the user may adhere to specific syntax requirements set by the database or application. For example, some databases or backend applications may not be accessible via an API, and may only execute queries in the structured query language (SQL). As another example, some databases or APIs may only execute queries adhering to a non-structured query language (NoSQL), and do not match SQL query language syntax. These are only a few examples of differing language syntaxes that could be used across multiple databases, applications or APIs to identify a given data set field name/value pair. In order for a user to effectively perform a query of two different databases, applications, or APIs using differing syntaxes, the user may be required to learn the proper syntax for each of these databases, applications or APIs. A solution is needed that allows a user to perform a query without having to learn the underlying syntax of the query language for each API or application.

The automated data set query suggestion system described in embodiments herein addresses this issue by allowing users to select commonly used queries, written in natural language, which the system may then translate to the proper query syntax for later execution of an integration process. Such natural language queries may include one or more query objects, representing nouns of a sentence, a query operator representing a verb of the sentence, and a query object value representing the direct object of the natural language sentence. For example, a natural language sentence “customer is John Smith” includes a query object “customer,” a query operator “is,” and a query object value “John Smith.” The query object in an embodiment may also correspond to the data set field name, and the query object value may correspond to the data set field value. For example, the data set field name in the above natural language sentence may be “customer,” while the data set field value for this field name may be “John Smith.”

A user in embodiments described herein may provide a user-specified query object via a dataset query selection user interface to initiate a query of a database, application or an API for data set field names described by the user-specified query object. For example, the dataset query selection user interface in embodiments may receive a user input identifying a user-specified query object “invoice” as part of a query for data set field names that involve the word “invoice.” The dataset query selection user interface in embodiments described herein may then display one or more previously executed, suggested software queries that involved the same user-identified query object “invoice.” Each of the suggested, previously executed software queries may be written in a natural language, easily understood by a user not familiar with specific software queries syntaxes. The user may then select one or more natural language sentences that best represent the search the user wishes to perform in a current or later execution of a software query.

An automated data set query suggestion system in embodiments described herein may operate to parse query objects, query operators, and data set sources queried (e.g., databases, applications, or APIs) in previously executed integration processes that involved a software query. Such previously executed software queries may have been executed pursuant to code instructions written in SQL or NoSQL formatting. Upon identification of such query parameters (e.g., query object, query operator, data set source queried) for such previously executed queries, the automated data set query suggestion system may generate a previously executed query database describing each query object and data set source queried, as well as the relationships between such objects and sources. Such a previously executed query database may be either relational or non-relational in various embodiments. In an embodiment in which such a previously executed query database is non-relational, the automated dataset query suggestion system may assign one or more previously executed query objects to a node of the previously executed query database, and multiple nodes may be connected to one another via edges that describe the relationships between the previously executed query objects or data set sources assigned to each connected node. These relationships may be written in a natural language in embodiments. For example, a first node of a previously executed query database may have a value “customer,” and may be connected to a second node having a value “phone number” via an edge having a value “may be contacted at.” Such a non-relational representation may represent the concept that a specific customer may be contacted at a specific phone number.

A user in embodiments described herein may use the customized data integration software application system to model a new integration process for future execution, which may include a new data set query. The user may be prompted to provide one or more query parameters for this new data set query via a dataset query selection user interface described herein. Upon receipt, via such a GUI, of a user-selected query object, or a user-defined data set source to be queried (e.g., an API such as Netsuite™), the automated data set query suggestion system may search the previously executed query database describing previously executed data set queries to identify one or more additional query parameters (e.g., query objects, query operators, or data set sources queried) that have been combined with the user-selected query object in previously executed searches. For example, a user may enter the user-selected query object “customer,” and the automated data set query suggestion system may determine the previously executed query database indicates previously executed searches that included the query object “customer” also included the query object “phone number.” Upon such a determination, the automated data set query suggestion system may generate a natural language sentence that includes both of these identified query objects, such as “a customer that may be contacted at a phone number.” The automated data set query suggestion system may then display the natural language selection via the GUI for selection by the user to be included within the new query the user is currently modeling for future execution.

Once a user selects a natural language sentence representing a software query the user wishes to execute currently or in the future, the automated data set query suggestion system in embodiments may automatically generate code instructions that include the previously executed software query, written in the proper syntax. By translating syntax specific queries into natural language sentences for user selection in such a way, the dataset query selection user interface and the automated data set query suggestion system in embodiments described herein may allow a user not familiar with or possessing little skill in query languages to understand what a given query will likely return. Further, automatic generation of code instructions including the previously executed software query may automate the process of accessing and retrieving data sets meeting search criteria, defined by the user's selection of a natural language sentence, from a database, API, or application without the user having to learn the proper query syntax for that database, API, or application.

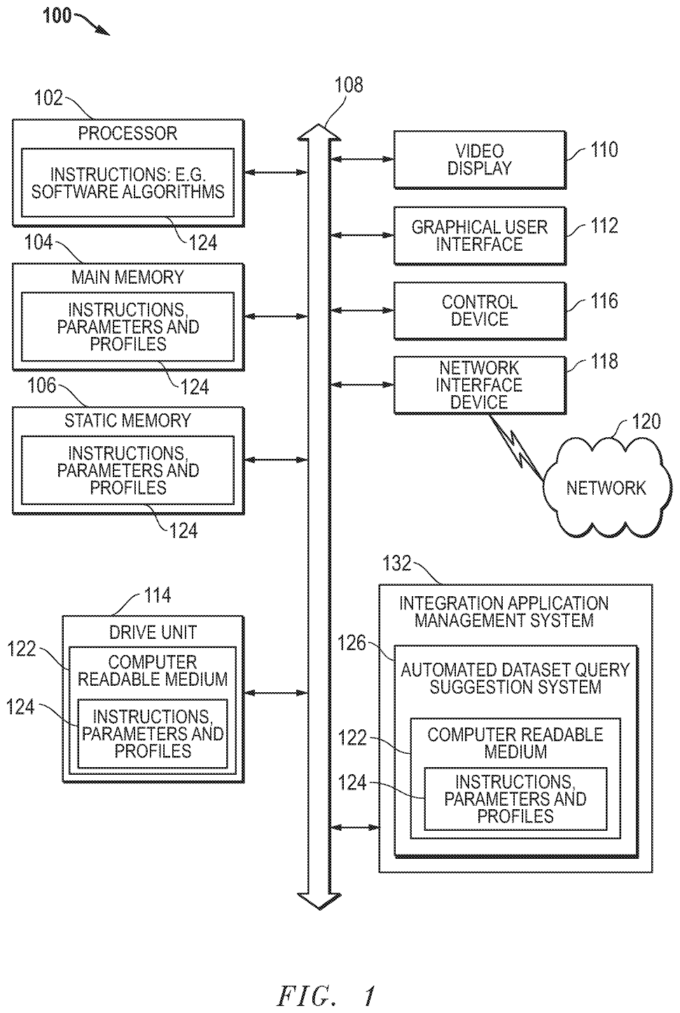

FIG. 1 is a block diagram illustrating an information handling system, according to an embodiment of the present disclosure. Information handling system 100 can include processing resources for executing machine-executable code, such as a central processing unit (CPU), a programmable logic array (PLA), an embedded device such as a System-on-a-Chip (SoC), or other control logic hardware used in an information handling system several examples of which are described herein. Information handling system 100 can also include one or more computer-readable media for storing machine-executable code, such as software or data. Additional components of information handling system 100 can include one or more storage devices that can store machine-executable code, one or more communications ports for communicating with external devices, and various input and output (I/O) devices, such as a keyboard, a mouse, and a video display. Information handling system 100 can also include one or more buses operable to transmit information between the various hardware components.

FIG. 1 illustrates an information handling system 100 similar to information handling systems according to several aspects of the present disclosure. For example, an information handling system 100 may be any mobile or other computing device capable of executing a set of instructions (sequential or otherwise) that specify actions to be taken by that machine. In a particular embodiment, the information handling system 100 can be implemented using electronic devices that provide voice, video, or data communication. Further, while a single information handling system 100 is illustrated, the term “system” shall also be taken to include any collection of systems or sub-systems that individually or jointly execute a set, or multiple sets, of instructions to perform one or more computer functions.

Information handling system 100 can include devices or modules that embody one or more of the devices or execute instructions for the one or more systems and modules herein, and operates to perform one or more of the methods. The information handling system 100 may execute code 124 for the automated data set query suggestion system 126, or the integration application management system 132 that may operate on servers or systems, remote data centers, or on-box in individual client information handling systems such as a local display device, or a remote display device, according to various embodiments herein. In some embodiments, it is understood any or all portions of code 124 for the automated data set query suggestion system 126, or the integration application management system 132 may operate on a plurality of information handling systems 100.

The information handling system 100 may include a processor 102 such as a central processing unit (CPU), a graphics-processing unit (GPU), control logic or some combination of the same. Any of the processing resources may operate to execute code that is either firmware or software code. Moreover, the information handling system 100 can include memory such as main memory 104, static memory 106, drive unit 114, or the computer readable medium 122 of the automated data set query suggestion system 126, or the integration application management system 132 (volatile (e.g. random-access memory, etc.), nonvolatile (read-only memory, flash memory etc.) or any combination thereof). Additional components of the information handling system can include one or more storage devices such as static memory 106, drive unit 114, and the computer readable medium 122 of the automated data set query suggestion system 126, or the integration application management system 132. The information handling system 100 can also include one or more buses 108 operable to transmit communications between the various hardware components such as any combination of various input and output (I/O) devices. Portions of an information handling system may themselves be considered information handling systems.

As shown, the information handling system 100 may further include a video display 110, such as a liquid crystal display (LCD), an organic light emitting diode (OLED), a flat panel display, a solid state display, or other display device. Additionally, the information handling system 100 may include a control device 116, such as an alpha numeric control device, a keyboard, a mouse, touchpad, camera, fingerprint scanner, retinal scanner, face recognition device, voice recognition device, or gesture or touch screen input.

The information handling system 100 may further include a graphical user interface 112. The graphical user interface 112 in an embodiment may provide a visual designer environment permitting a user to define process flows between applications/systems, such as between trading partner and enterprise systems, and to model a customized business integration process. The graphical user interface 112 in an embodiment may provide a menu of pre-defined user-selectable visual elements and permit the user to arrange them as appropriate to model a process and may be displayed on the video display 110. The elements may include visual, drag-and-drop icons representing specific units of work required as part of the integration process, such as invoking an application-specific connector, transforming data from one format to another, routing data down multiple paths of execution by examining the contents of the data, business logic validation of the data being processed, etc.

Further, the graphical user interface 112 allows the user to provide user input providing information relating to trading partners, activities, enterprise applications, enterprise system attributes, and/or process attributes that are unique to a specific enterprise end-to-end business integration process. For example, the graphical user interface 112 may provide drop down or other user-selectable menu options for identifying trading partners, application connector and process attributes/parameters/settings, etc., and dialog boxes permitting textual entries by the user, such as to describe the format and layout of a particular data set to be sent or received, for example, a Purchase Order. The providing of this input by the user results in the system's receipt of such user-provided information as an integration process data profile code set. The graphical user interface 112 in an embodiment may include a dataset query selection user interface, or an integration process flow modeling user interface in various embodiments described in greater detail herein.

In some embodiments, the graphical user interface 112 may also allow a user to provide one or more search terms that may be used to identify data set field values affected by one or more integration processes. A user in such an embodiment may interact with such a graphical user interface 112 to include terms used by integration application management system 132 to search for field values to transmit or migrate within an integration process.

The information handling system 100 can represent a server device whose resources can be shared by multiple client devices, or it can represent an individual client device, such as a desktop personal computer, a laptop computer, a tablet computer, or a mobile phone. In a networked deployment, the information handling system 100 may operate in the capacity of a server or as a client user computer in a server-client user network environment, or as a peer computer system in a peer-to-peer (or distributed) network environment.

The information handling system 100 can include a set of instructions 124 that can be executed to cause the computer system to perform any one or more of the methods or computer based functions disclosed herein. For example, information handling system 100 includes one or more application programs 124, and Basic Input/Output System and Firmware (BIOS/FW) code 124. BIOS/FW code 124 functions to initialize information handling system 100 on power up, to launch an operating system, and to manage input and output interactions between the operating system and the other elements of information handling system 100. In a particular embodiment, BIOS/FW code 124 reside in memory 104, and include machine-executable code that is executed by processor 102 to perform various functions of information handling system 100. In another embodiment (not illustrated), application programs and BIOS/FW code reside in another storage medium of information handling system 100. For example, application programs and BIOS/FW code can reside in static memory 106, drive 114, in a ROM (not illustrated) associated with information handling system 100 or other memory. Other options include application programs and BIOS/FW code sourced from remote locations, for example via a hypervisor or other system, that may be associated with various devices of information handling system 100 partially in memory 104, storage system 106, drive unit 114 or in a storage system (not illustrated) associated with network interface device 118 or any combination thereof. Application programs 124, and BIOS/FW code 124 can each be implemented as single programs, or as separate programs carrying out the various features as described herein. Application program interfaces (APIs) such as WinAPIs (e.g. Win32, Win32s, Win64, and WinCE), proprietary APIs (e.g., for SalesForce™ or Oracle's™ NetSuite™), or an API adhering to a known open source specification (e.g., Swagger™) may enable application programs 124 to interact or integrate operations with one another.

In an example of the present disclosure, instructions 124 may execute software for identifying, using natural language, data set field values located pursuant to software search queries given in specific query syntaxes or languages. The computer system 100 may operate as a standalone device or may be connected, such as via a network, to other computer systems or peripheral devices.

Main memory 104 may contain computer-readable medium (not shown), such as RAM in an example embodiment. An example of main memory 104 includes random access memory (RAM) such as static RAM (SRAM), dynamic RAM (DRAM), non-volatile RAM (NV-RAM), or the like, read only memory (ROM), another type of memory, or a combination thereof. Static memory 106 may contain computer-readable medium (not shown), such as NOR or NAND flash memory in some example embodiments. The disk drive unit 114, and the automated data set query suggestion system 126, or the integration application management system 132 may include a computer-readable medium 122 such as a magnetic disk, or a solid-state disk in an example embodiment. The computer-readable medium of the memory 104, storage devices 106 and 114, the automated data set query suggestion system 126, or the integration application management system 132 may store one or more sets of instructions 124, such as software code corresponding to the present disclosure.

The disk drive unit 114, static memory 106, and computer readable medium 122 of the automated data set query suggestion system 126, or the integration application management system 132 also contain space for data storage such as an information handling system for managing locations of executions of customized integration processes in endpoint storage locations. Connector code sets, and trading partner code sets may also be stored in part in the disk drive unit 114, static memory 106, or computer readable medium 122 of the automated data set query suggestion system 126, or the integration application management system 132 in an embodiment. In other embodiments, data profile code sets, and run-time engines may also be stored in part or in full in the disk drive unit 114, static memory 106, or computer readable medium 122 of the automated data set query suggestion system 126, or the integration application management system 132. Further, the instructions 124 of the automated data set query suggestion system 126, or the integration application management system 132 may embody one or more of the methods or logic as described herein.

In a particular embodiment, the instructions, parameters, and profiles 124, and the automated data set query suggestion system 126, or the integration application management system 132 may reside completely, or at least partially, within the main memory 104, the static memory 106, disk drive 114, and/or within the processor 102 during execution by the information handling system 100. Software applications may be stored in static memory 106, disk drive 114, the automated data set query suggestion system 126, or the integration application management system 132.

Network interface device 118 represents a NIC disposed within information handling system 100, on a main circuit board of the information handling system, integrated onto another component such as processor 102, in another suitable location, or a combination thereof. The network interface device 118 can include another information handling system, a data storage system, another network, a grid management system, another suitable resource, or a combination thereof, and may communicate via a wired connection or wirelessly.

The automated data set query suggestion system 126, or the integration application management system 132 may also contain computer readable medium 122. While the computer-readable medium 122 is shown to be a single medium, the term “computer-readable medium” includes a single medium or multiple media, such as a centralized or distributed database, and/or associated caches and servers that store one or more sets of instructions. The term “computer-readable medium” shall also include any medium that is capable of storing, encoding, or carrying a set of instructions for execution by a processor or that cause a computer system to perform any one or more of the methods or operations disclosed herein.

In a particular non-limiting, exemplary embodiment, the computer-readable medium can include a solid-state memory such as a memory card or other package that houses one or more non-volatile read-only memories. Further, the computer-readable medium can be a random access memory or other volatile re-writable memory. Additionally, the computer-readable medium can include a magneto-optical or optical medium, such as a disk or tapes or other storage device to store information received via carrier wave signals such as a signal communicated over a transmission medium. Furthermore, a computer readable medium can store information received from distributed network resources such as from a cloud-based environment. A digital file attachment to an e-mail or other self-contained information archive or set of archives may be considered a distribution medium that is equivalent to a tangible storage medium. Accordingly, the disclosure is considered to include any one or more of a computer-readable medium or a distribution medium and other equivalents and successor media, in which data or instructions may be stored.

The information handling system 100 may also include the automated data set query suggestion system 126, or the integration application management system 132, which may be operably connected to the bus 108. The automated data set query suggestion system 126 is discussed in greater detail herein below.

In other embodiments, dedicated hardware implementations such as application specific integrated circuits, programmable logic arrays and other hardware devices can be constructed to implement one or more of the methods described herein. Applications that may include the apparatus and systems of various embodiments can broadly include a variety of electronic and computer systems. One or more embodiments described herein may implement functions using two or more specific interconnected hardware modules or devices with related control and data signals that can be communicated between and through the modules, or as portions of an application-specific integrated circuit. Accordingly, the present system encompasses software, firmware, and hardware implementations.

When referred to as a “system”, a “device,” a “module,” or the like, the embodiments described herein can be configured as hardware. For example, a portion of an information handling system device may be hardware such as, for example, an integrated circuit (such as an Application Specific Integrated Circuit (ASIC), a Field Programmable Gate Array (FPGA), a structured ASIC, or a device embedded on a larger chip), a card (such as a Peripheral Component Interface (PCI) card, a PCI-express card, a Personal Computer Memory Card International Association (PCMCIA) card, or other such expansion card), or a system (such as a motherboard, a system-on-a-chip (SoC), or a stand-alone device). The system, device, or module can include software, including firmware embedded at a device, such as an Intel® Core class processor, ARM® brand processors, Qualcomm® Snapdragon processors, or other processors and chipset, or other such device, or software capable of operating a relevant environment of the information handling system. The system, device or module can also include a combination of the foregoing examples of hardware or software. In an example embodiment, the automated data set query suggestion system 126, or the integration application management system 132 and the several modules described in the present disclosure may be embodied as hardware, software, firmware or some combination of the same. Note that an information handling system can include an integrated circuit or a board-level product having portions thereof that can also be any combination of hardware and software. Devices, modules, resources, or programs that are in communication with one another need not be in continuous communication with each other, unless expressly specified otherwise. In addition, devices, modules, resources, or programs that are in communication with one another can communicate directly or indirectly through one or more intermediaries.

In accordance with various embodiments of the present disclosure, the methods described herein may be implemented by software programs executable by a computer system. Further, in an exemplary, non-limited embodiment, implementations can include distributed processing, component/object distributed processing, and parallel processing. Alternatively, virtual computer system processing can be constructed to implement one or more of the methods or functionality as described herein.

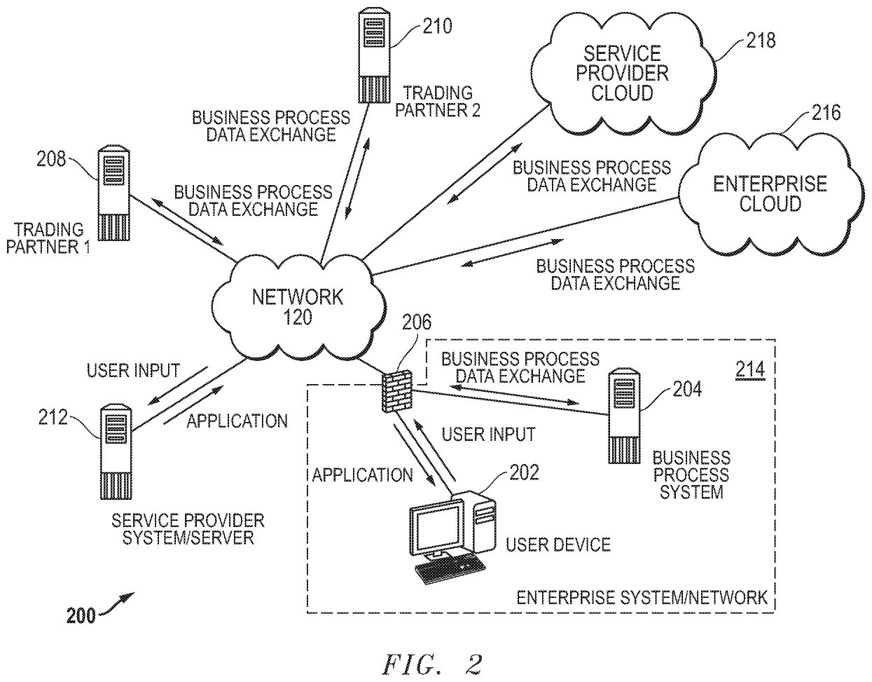

FIG. 2 is a graphical diagram illustrating a simplified integration network 200 including a service provider system/server 212 and an enterprise system/network 214 in an embodiment according to the present disclosure. Actual integration network topology could be more complex in some other embodiments. As shown in FIG. 2, an embodiment may include conventional computing hardware of a type typically found in client/server computing environments. More specifically, the integration network 200 in an embodiment may include a conventional user/client device 202, such as a conventional desktop or laptop PC, enabling a user to communicate via the network 120, such as the Internet. In another aspect of an embodiment, the user device 202 may include a portable computing device, such as a computing tablet, or a smart phone. The user device 202 in an embodiment may be configured with conventional web browser software, such as Google Chrome®, Firefox®, or Microsoft Corporation's Internet Explorer® for interacting with websites via the network 120. In an embodiment, the user device 202 may be positioned within an enterprise network 214 behind the enterprise network's firewall 206, which may be of a conventional type. As a further aspect of an embodiment, the enterprise network 214 may include a business process system 204, which may include conventional computer hardware and commercially available business process software such as QuickBooks, SalesForce's™ Customer Relationship Management (CRM) Platform, Oracle's™ Netsuite Enterprise Resource Planning (ERP) Platform, Infor's™ Warehouse Management Software (WMS) Application, or many other types of databases.

In an embodiment, the integration network 200 may further include trading partners 208 and 210 operating conventional hardware and software for receiving and/or transmitting data relating to business-to-business transactions. For example, Walmart® may operate trading partner system 208 to allow for issuance of purchase orders to suppliers, such as the enterprise 214, and to receive invoices from suppliers, such as the enterprise 214, in electronic data form as part of electronic data exchange processes. Electronic data exchange process in an embodiment may include data exchange via the world wide web. In other embodiments, electronic data exchange processes may include data exchange via File Transfer Protocol (FTP) or Secure File Transfer Protocol (SFTP).

In an embodiment, a provider of a service (“service provider”) for creating on-demand, real-time creation of customized data integration software applications may operate a service provider server/system 212 within the integration network 200. The service provider system/server 212 may be specially configured in an embodiment, and may be capable of communicating with devices in the enterprise network 214. The service provider system/server 212 in an embodiment may host an integration process-modeling user interface in an embodiment. Such an integration process-modeling user interface may allow a user or the automated data set query suggestion system to model an integration process including one or more sub-processes for data integration through a business process data exchange between an enterprise system/network 214 and outside entities or between multiple applications operating at the business process system 204. The integration process modeled in the integration process-modeling user interface in an embodiment may be a single business process data exchange shown in FIG. 2, or may include several business process data exchanges shown in FIG. 2. For example, the enterprise system/network 214 may be involved in a business process data exchange via network 120 with a trading partner 1, and/or a trading partner 2. In other example embodiments, the enterprise system/network 214 may be involved in a business process data exchange via network 120 with a service provider located in the cloud 218, and/or an enterprise cloud location 216. For example, one or more applications between which a data set field value may be transferred, according to embodiments described herein, may be located remotely from the enterprise system 214, at a service provider cloud location 218, or an enterprise cloud location 216.

The automated data set query suggestion system, used with an integration process-modeling user interface in an embodiment may model one or more business process data exchanges via network 120 within an integration process by adding one or more connector integration elements or code sets to an integration process flow. These connector integration elements in an embodiment may model the ways in which a user wishes data to be accessed, moved, and/or manipulated during the one or more business process data exchanges. Each connector element the automated data set query suggestion system or the user adds to the integration process flow diagram in an embodiment may be associated with a pre-defined subset of code instructions stored at the service provider systems/server 212 in an embodiment. Upon the user modeling the integration process, the service provide system/server 212 in an embodiment may generate a run-time engine capable of executing the pre-defined subsets of code instructions represented by the connector integration elements chosen by the user or indicated by the automated data set query suggestion system. The runtime engine may then execute the subsets of code instructions in the order defined by the modeled flow of the connector integration elements given in the integration process flow diagram. In some embodiments, the automated data set query suggestion system may define the order in which such subsets of code instructions are executed by the runtime engine without creation of or reference to a visual integration process flow diagram. In such a way, an integration process may be executed without the user having to access, read, or write the code instructions of such an integration process.

In other aspects of an embodiment, a user may initiate a business process data exchange between one cloud service provider 218 and one cloud enterprise 216, between multiple cloud service providers 218 with which the enterprise system 214 has an account, or between multiple cloud enterprise accounts 216. For example, enterprise system 214 may have an account with multiple cloud-based service providers 218, including a cloud-based SalesForce™ CRM account and a cloud-based Oracle™ Netsuite™ account. In such an embodiment, the enterprise system 214 may initiate business process data exchanges between itself, the SalesForce™ CRM service provider and the Oracle™ Netsuite service provider.

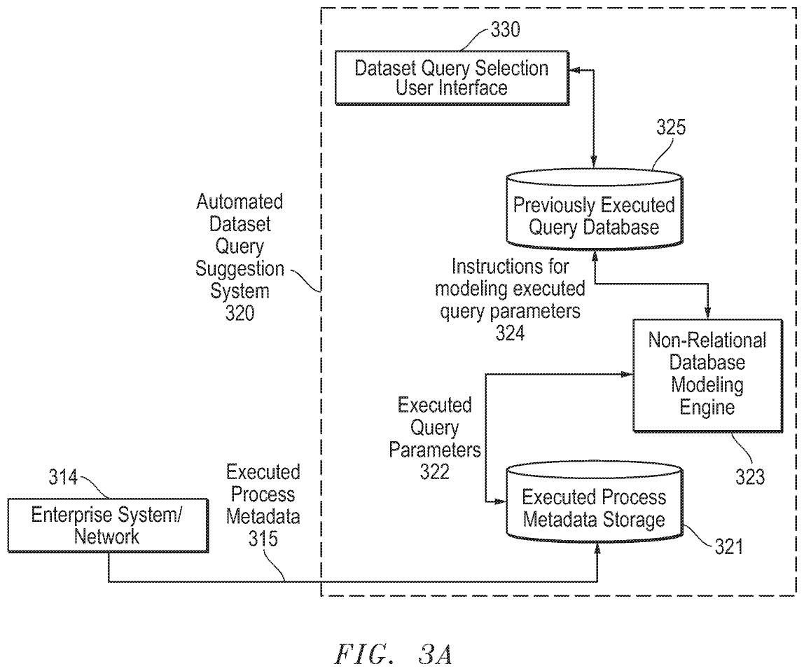

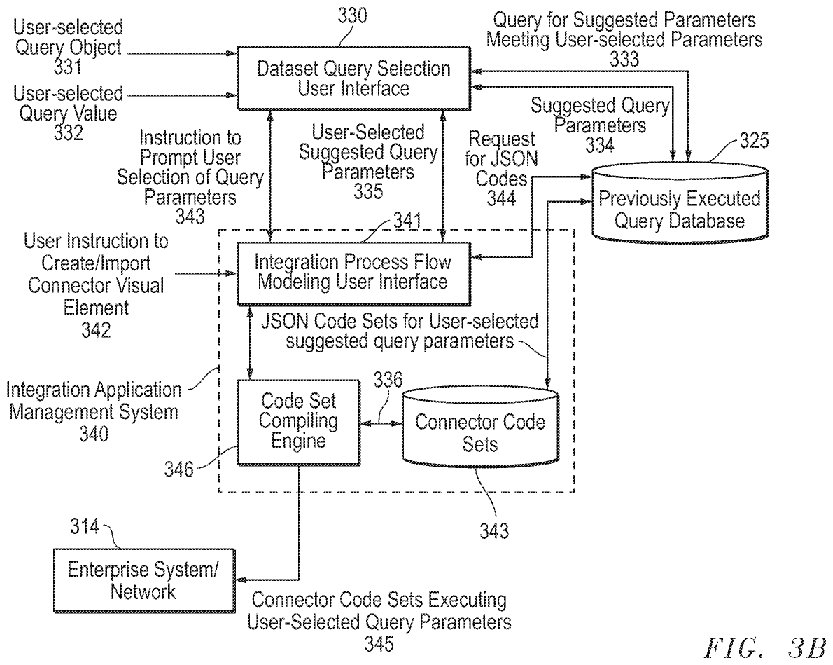

FIG. 3A is a graphical diagram illustrating an automated data set query suggestion system including a previously executed query database, in communication with an enterprise system according to an embodiment of the present disclosure. As described herein, the automated data set query suggestion system allows users to select commonly used queries appearing in previously executed integration processes. Such previously executed integration processes in an embodiment may be executed at the enterprise system/network 314 in an embodiment.

The enterprise system/network 314 in an embodiment may be in communication with an automated dataset query suggestion system 320. For example, upon such an execution, the enterprise system/network 314 in such an embodiment may transmit executed process metadata 315 to the executed process metadata storage database 321 of the automated dataset query suggestion system 320. The executed process metadata 315 in such an embodiment may describe any query parameters (e.g., query object, query operator, query object value, dataset source queried) applied to a query performed within the previously executed integration process by the enterprise system/network 314, as well as the number of queries performed, and whether such queries were joined with one another. The executed process metadata storage database 321 in an embodiment may store such metadata, as received from any number of customers, including the enterprise system/network 314 in a database managed by the service provider described above with reference to FIG. 2, which may manage the entire automated dataset query suggestion system. In other words, the previously executed query performed by the enterprise system/network 314 in such an embodiment may have been performed remotely from the automated dataset query suggestion system 320, which may reside at the service provider.

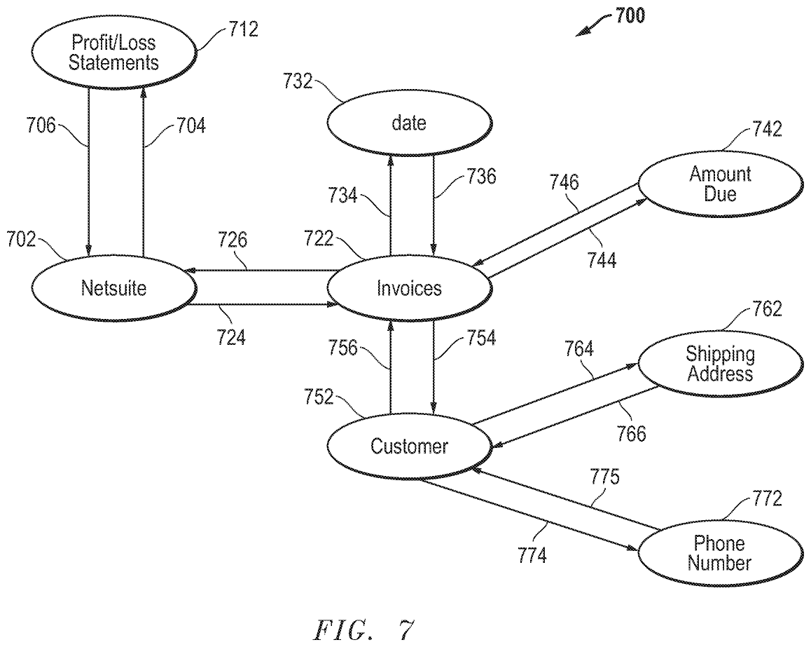

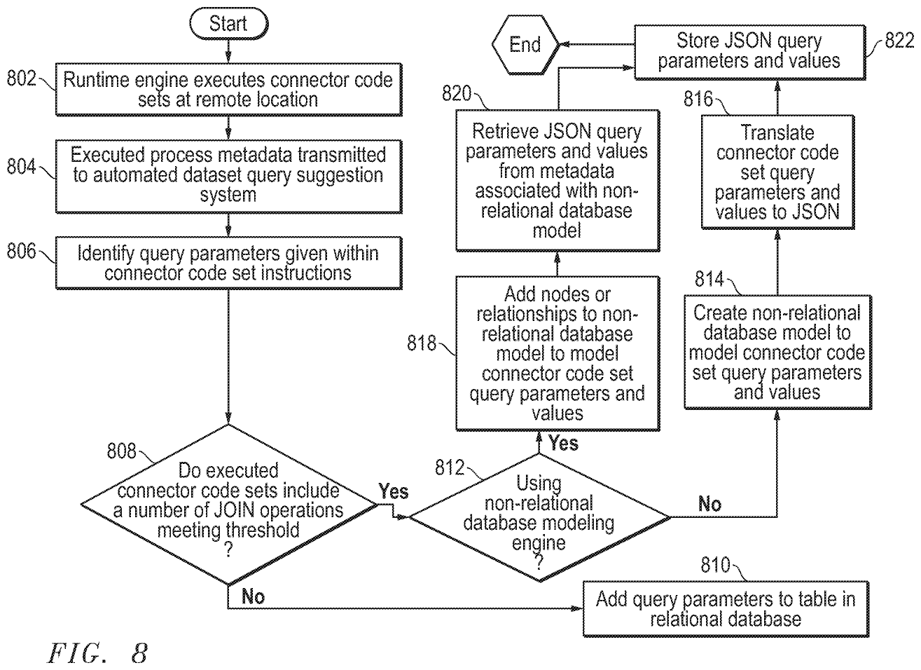

The automated dataset query suggestion system 320 in an embodiment may transmit executed query parameters 322 for sorting by the non-relational database-modeling engine 323 and storage at the previously executed query database 325 in an embodiment. Such executed query parameters 322 in an embodiment may take the form of JSON code sets describing the query parameters (e.g., query object, query operator, query object value) of the previously executed query performed by the enterprise system/network 314. As described herein, information describing each query performed pursuant to an executed integration process across multiple clients in an embodiment may be stored in a previously executed query database for later use in suggesting queries for similar future queries (e.g., future queries including the same query object, query operator, or queried application). As such, the executed process metadata 315 and the executed query parameters 322 in an embodiment may be drawn from a plurality of the service provider's customers, or crowd-sourced across multiple integration processes. As described in greater detail herein with reference to FIGS. 7 and 8, the non-relational database-modeling engine 323 of the automated dataset query suggestion system 320 may parse the executed query parameter sets 322 received from the executed process metadata storage 321 to identify separate query objects, query operators, and query object values. The automated dataset query suggestion system 320 may then transmit instructions for modeling each of these parsed query objects, within the executed query parameters to the previously executed query database 325.

As described herein in greater detail with reference to FIGS. 7 and 8, previously executed query objects (as parsed from the executed query parameters 322 by the non-relational database-modeling engine 323) may be stored in one or more non-relational databases within the previously executed query database. Relational databases present a more traditional approach to storage of information that is interrelated. Such relational databases may store information in a plurality of tables, with each table representing a relationship between two types of data values. For example, a table may include one column of values for invoice numbers, and another column of values for invoice dates, where each row representing the date given in an invoice of the shown invoice number. Another table may include one column of values for invoice numbers, and another column of values for amounts due, with each row representing the amount due given in an invoice of the shown invoice number.

In order to represent further information about a given invoice using such a relational, or table-based structure, a relational database may be added to, or scaled upward. Two types of such upward scaling are available for relational databases, including horizontal and vertical scaling. Horizontal scaling of a relational database may include addition of rows to an existing table. For example, a table having a column for invoice number and a column for invoice date may add a row to record a date on an invoice that had not been previously recorded within this same table. Such horizontal scaling, however, may only allow for inclusion of the same type of information already given in the existing table (e.g., invoice number and invoice date). Vertical scaling of a relational database may include addition of a new table that includes a combination of dataset values previously not found in any existing table. For example, a new table having a column for invoice number and a column for customer name may be created, if no existing tables include those two columns in combination with one another. In such a way, vertical scaling may represent relationships between information that had previously not been represented in existing tables.

Relational databases present certain obstacles to efficient storage and querying of data sets as those data sets become increasingly interrelated or correlated to one another, and the relational database must be scaled. For example, horizontal scaling may not address an increase in the number of relationships between dataset values or types. As another example, the addition of new tables for every newly established connection in a vertical scaling approach may require impractical amounts of storage space. Non-relational databases may overcome such obstacles by using interrelated nodes, rather than tables to describe relationships between interconnected data sets in an embodiment.

Non-relational databases in an embodiment may model multiple nodes, with each node representing the same data sets that may be stored in one or more cells of a table within a relational database. This approach may obviate the need for a potentially unmanageably large number of tables required to represent the same interrelated information. Each of such previously executed, parsed query objects may be represented by a node, and multiple nodes may be connected via edges, with each edge describing a natural language clause representing the relationship between the nodes it connects. The previously executed query database 325 in an embodiment may also be in communication with a dataset query selection user interface 330 which users may employ to search the non-relational database stored within the previously executed query database 325 in order to identify previously executed remote query parameter sets similar to a currently modeled query for later execution.

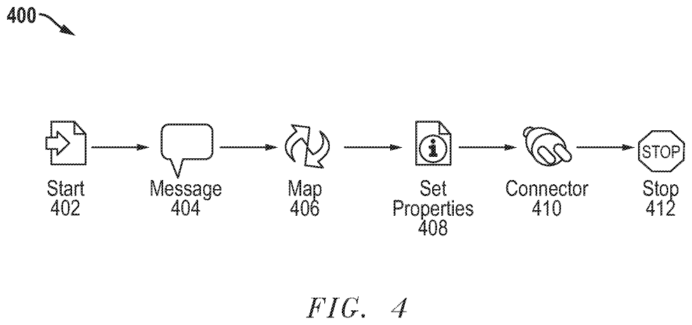

FIG. 3B is a graphical diagram illustrating an integration application management system in communication with an automated data set query suggestion system according to an embodiment of the present disclosure. As described in greater detail with respect to FIG. 4, a user may generate a flow diagram in an embodiment by providing a chronology of process-representing integration elements via the use of an integration process-modeling user interface 341, managed by the integration application management system 340. An integration process-modeling user interface 341 in an embodiment may provide a design environment permitting a user to define process flows using a menu of pre-defined user-selectable elements representing integration sub-processes, and permit the user to arrange them as appropriate to model a full integration process. For example, in an embodiment in which the integration process-modeling user interface is a graphical user interface, the elements may include visual, drag-and-drop icons representing specific units of work (known as process components) required as part of the integration process. Such a process component, in an embodiment, may include a user instruction 342 to create a connector visual element, invoking an application-specific connector to access, and/or manipulate data. Adding such a connector visual element to the process flow via the integration process-modeling user interface 341 may allow a user to choose from different actions the “connector” component may be capable of taking on the data as it enters that process step in an embodiment.

Further the integration-process modeling user interface 341 in an embodiment may allow the user to choose the data set or data element upon which the action will be taken. For example, the user instruction 342 to create a connector visual element may include instructions to retrieve a data set stored within a searchable database (or within a backend application accessible via an API supporting a database type query capability) that meet the parameters of a user-defined search query or a suggested query provided by the automated data set query suggestion system. Upon receipt of the user instruction 342 indicating the data set the connector visual element operates on will be identified using a remote software query, the integration process flow modeling user interface 341 may transmit an instruction to the dataset query selection user interface 330 to prompt the user to provide user-selected query parameters 343 for such a remote software query.

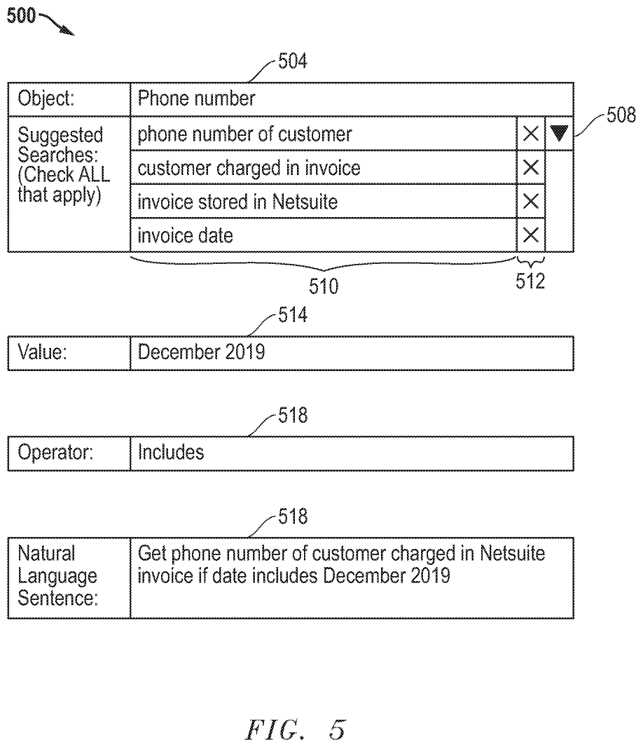

As described herein, the automated data set query suggestion system, including the dataset query selection user interface 330, allows users to select commonly used queries, written in natural language, which the system may then translate to the proper query syntax for later execution of an integration process. Such natural language queries may include one or more query objects, representing nouns of a sentence, a query operator representing a verb of the sentence, and a query object value representing the direct object of the natural language sentence. A user may provide a user-selected query object 331, and a user-selected query object value 332 via the dataset query selection user interface 330. For example, a user may provide a user-selected query object “date,” and a user-selected query object value “December 2019,” via a dataset query selection user interface 330, as described in greater detail with respect to FIG. 5. These user-selected query object 331 and query object value 332 in an embodiment may comprise a set of user-specified query parameters. Such a set of user-specified query parameters may further include, in some embodiments, a query operator, such as “includes,” which may be combined with the user-selected query object 331 (e.g., “date”) and user-selected query object value 332 (e.g., “December 2019”) to form a natural language clause “date includes December 2019.”

The dataset query selection user interface 330 in such an embodiment may communicate with the previously executed query database 325 in an embodiment to determine whether other remote queries that include the user-selected query object 331 have been previously executed. Such remote queries may have been performed in the past to query remote data set sources (e.g., APIs, applications, or remote databases not controlled by or operating within the automated dataset query suggestion system), as described in greater detail with respect to FIG. 3A, above. In other words, such previously executed queries in an embodiment may have been performed to search databases other than the previously executed queries database 325, or any other databases shown within FIGS. 3A and 3B.

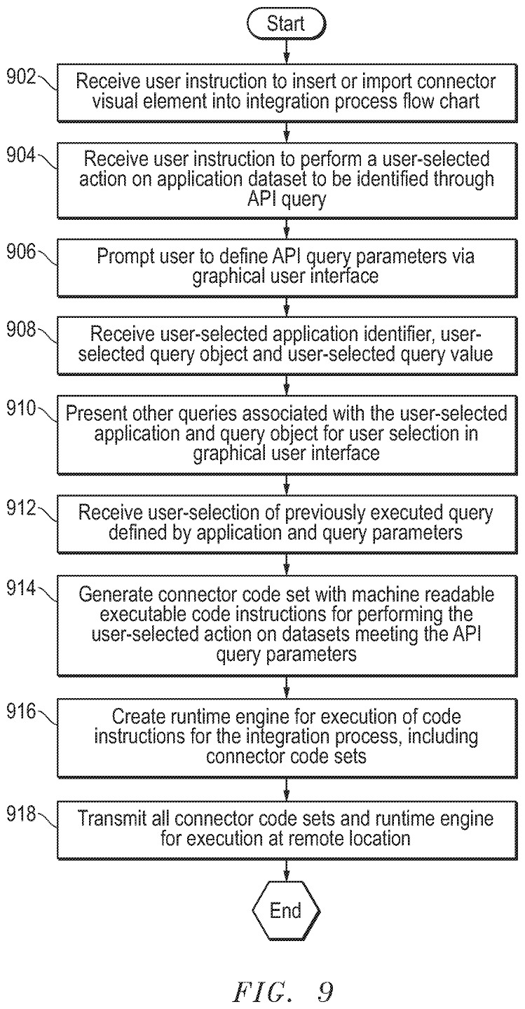

A user in embodiments described herein may provide a user-specified query object via a dataset query selection user interface to initiate a query of a database, application or an API for data set field names described by the user-specified query object. For example, the dataset query selection user interface 330 in embodiments may receive a user input identifying a user-specified query object “date” as part of a query for data set field names that involve the word “date.” The dataset query selection user interface 330 may transmit instructions 333 to search across the non-relational database of the previously executed query database 325 for suggested query parameters related to the user-selected query object 331. As described in greater detail with reference to FIGS. 7 and 9, the previously executed query database 325 in such an embodiment may return search results indicating the user-specified query object 331 has been associated with the query objects “phone number,” “customer,” “invoice,” “Netsuite™,” and “date” in previously executed remote queries. The automated dataset query suggestion system in an embodiment may combine these previously executed remote query objects into a natural language sentence using the relationships between the nodes representing each of these previously executed remote query objects, represented as edges within the previously executed query database 325, which may adhere to a non-relational structure. The automated dataset query suggestion system may then transmit the suggested query parameters 334, in the form of a natural language sentence, for display via the dataset query selection user interface 330. A user may then select the natural language sentence for inclusion within an integration currently being modeled via the integration process flow modeling user interface 341, for later execution at the enterprise system/network 314.

Upon such a user selection in an embodiment, the dataset query selection user interface 330 may transmit the user-selected, suggested query parameters 335 within the user-selected natural language sentence to the integration process flow modeling user interface 341. The user-selected, suggested query parameters 335 in such an example embodiment may then be incorporated by the integration application management system 340 into the modeled integration process. For example, the connector visual element added to the process flow model via user instruction 342 may describe an action to be performed on a dataset to be identified using the user-selected, suggested query parameters 335.

Once the integration application management system 340 incorporates the user-selected, suggested query parameters 335 within the integration process flow model in an embodiment, the integration process flow modeling user interface 341 may request the JSON code sets associated with the user-selected, suggested query parameters, as stored in the previously executed query database 325. The automated dataset query suggestion system may locate such JSON code sets 336 and transmit them to the connector code set storage 343 of the integration application management system 340.

The integration application management system 340 in such an embodiment may also include a code set compiling engine 346 which may operate to combine these JSON code sets 336, associated with the user-selected suggested query parameters within the connector code sets associated with the user-defined action to be performed on the dataset meeting these query parameters 335. The code set compiling engine 346 may be in communication with the integration process flow modeling user interface in order to determine which code sets to combine together, and in which order, to reflect the integration process modeled via the integration process flow modeling user interface. The code set compiling engine 346 may then retrieve the JSON code sets 336 to combine them with other code sets represented by various other visual elements within the user-modeled integration process flow to create an executable set of code instructions for the full integration process. The code set compilation engine 346 in an embodiment may then compile these JSON code instructions into machine-executable code instructions and transmit this compiled code set, including a compiled version of connector code set 345, executing the user-selected query parameters, and a runtime engine to the enterprise system/network 314. Upon initiation of such a runtime engine at the enterprise system/network 314 in an embodiment, the connector code set and the remote software query employing the user-selected query parameters may be executed on a remote dataset source (e.g., external application, API, or database not shown in FIG. 3A or 3B).

FIG. 4 is a graphical diagram illustrating a user-generated flow diagram of an integration process for exchange of electronic data records according to an embodiment of the present disclosure. The flow diagram in an embodiment may be displayed within a portion of a integration process flow modeling user interface 400 that allows the user to build the process flow, deploy the integration process modeled thereby, and manage data set field values manipulated by such an integration process. Similar to 341 in FIG. 3B, a user may generate a flow diagram in an embodiment by providing a chronology of process-representing integration elements via the use of an integration process-modeling user interface. In some embodiments, the integration process-modeling user interface may take the form of a graphical user interface. In such embodiments, the user-selectable elements representing integration sub-processes (e.g. connector integration elements) may be visual icons.

An integration process-modeling user interface in an embodiment may provide a design environment permitting a user to define process flows between applications/systems, such as between trading partner and enterprise systems, between on-site data centers and cloud-based storage modules, or between multiple applications, and to model a customized business integration process. Such an integration process-modeling user interface in an embodiment may provide a menu of pre-defined user-selectable elements representing integration sub-processes and permit the user or the data integration protection assistance system to arrange them as appropriate to model a full integration process. For example, in an embodiment in which the integration process-modeling user interface is a graphical user interface, the elements may include visual, drag-and-drop icons representing specific units of work (known as process components) required as part of the integration process. Such a process components in an embodiment may include invoking an application-specific connector to access, and/or manipulate data. In other embodiments, process components may include tasks relating to transforming data from one format to another, routing data down multiple paths of execution by examining the contents of the data, business logic validation of the data being processed, etc.

Each process component as represented by integration sub-process icons or elements may be identifiable by a process component type, and may further include an action to be taken. For example, a process component may be identified as a “connector” component. Each “connector” component, when chosen and added to the process flow in the integration process-modeling user interface, may allow a user to choose from different actions the “connector” component may be capable of taking on the data as it enters that process step. Further the integration-process modeling user interface in an embodiment may allow the user to choose the data set or data element upon which the action will be taken. The action and data element the user chooses may be associated with a connector code set, via the integration application management system, which may be pre-defined and stored at a system provider's memory in an embodiment.

For example, a user in an embodiment may create and customize a “connector” component to represent the action of retrieving data sets stored within a searchable database (or within a backend application accessible via an API supporting a database type query capability) that meet the parameters of a user-defined search query or a suggested query provided by the automated data set query suggestion system. In embodiments described herein, references made to searchable databases may include such query-capable APIs working in combination with corresponding backend applications controlling or managing data sets. A data set may include a data set field name describing the type of information stored therein, and a data set field value providing a unique subset of information within that category or of that type. For example, a data set describing a customer identification may include a data set field name “customer,” and a data set field value “John Smith.”

A remote software query may be used to locate multiple of such data sets that include the same or similar information meeting the user-specified query parameters. As described herein, such query parameters may be given in a natural language sentence that may include one or more query objects, representing nouns of a sentence, a query operator representing a verb of the sentence, and a query object value representing the direct object of the natural language sentence. For example, a natural language sentence “customer is John Smith” includes a query object “customer,” a query operator “is,” and a query object value “John Smith.” The query object in an embodiment may also correspond to the data set field name, and the query object value may correspond to the data set field value. For example, the data set field name in the above natural language sentence may be “customer,” while the data set field value for this field name may be “John Smith.” The query parameter set in such an example may include the query object “customer,” the query operator “is,” and the query object value “John Smith,” and may operate to retrieve data sets in which the data set field name is “customer,” and the data set field value is “John Smith.”

The integration application management system in an embodiment may generate a customized connector code set for executing the user-defined query, based on the “connector” component customized by the user. When customizing the “connector” component in an embodiment, the user may provide, via a dataset query selection user interface described in greater detail with respect to FIG. 5, the user-defined query parameters, as well as an action to be performed on data sets meeting the user-defined query parameters. The action to be performed on data sets in such an embodiment may be defined via the integration process flow modeling user interface described with reference to FIG. 4, and may relate to common actions performed on data sets during integration processes, such as Create, Retrieve (e.g., GET), Update, or Delete (CRUD). In contrast, the query operator in an embodiment may represent a verb within a natural language sentence describing data sets upon which such an action may be executed, and may be provided by the user via the dataset query selection user interface described with reference to FIG. 5. For example, a full natural language sentence describing a remote software query may be “Get invoice if customer is John Smith.” In such an example, the action may be “get” (e.g., retrieve), “invoice” may be a query object, “customer” may be a query object, “John Smith” may be the query object value for the query object “customer,” and the query operator may be “is.” Thus, the query operator may describe the relationship between the query object and the query object value within the conditional clause beginning with the word “if,” while the action (e.g., “get”) defines the action to be taken on data sets meeting the query parameters within the conditional clause.

The integration application management system in an embodiment may receive each of these user-defined query parameters via the dataset query selection user interface described with respect to FIG. 5, including the query objects (e.g., “invoice,” and “Contact”), the query operator (“is”) and the query value (e.g., “John Smith”), and generate a connector code set capable of executing the query defined by these parameters. Such a connector code set may be written in structured query language (SQL) or non-structured query language (NoSQL), depending upon the language understood by and the structure in which the data set is stored by the source of the data set, or the backend application managing such data sets. The integration application management system operating at least partially at a system provider server/system in an embodiment may generate a dynamic runtime engine for executing these pre-defined subsets of code instructions correlated to each individual process-representing visual element (process component) in a given flow diagram in the order in which they are modeled in the given flow diagram, or by the system for translating a software query into natural language in a non-visual format.

In an embodiment, a user may choose a process component it uses often when interfacing with a specific trade partner or application, and define the parameters of that process component by providing parameter values specific to that trading partner or application. If the user wishes to use this process component, tailored for use with that specific trading partner or application repeatedly, the user may save that tailored process component as a trading partner or component named specifically for that application. For example, if the user often accesses NetSuite™ or SalesForce™, the user may create a database connector process component, associated with a pre-built connector code set that may be used with any database, then tailor the database connector process component to specifically access NetSuite™ or SalesForce™ by adding process component parameters associated with one of these applications. If the user uses this process component in several different integration processes, the user may wish to save this process component for later use by saving it as a NetSuite™ or SalesForce™ process component. In the future, if the user wishes to use this component, the user may simply select the NetSuite™ or SalesForce™ component, rather than repeating the process of tailoring a generic database connector process component with the specific parameters defined above.

As shown in FIG. 4, such process-representing visual elements may include a start element 402, a message element 404, a map element 406, a set properties element 408, a connector element 410, and a stop element 412. Other embodiments may also include a branch element, a decision element, a data process element, or a process call element, for example. A connector element 410, and a start element 402 in an embodiment may represent a sub-process of an integration process describing the accessing and/or manipulation of data. The start element 402 in an embodiment may also operate as a connector element.

In an embodiment, a start element 402 may operate to begin a process flow, and a stop element 412 may operate to end a process flow. As discussed above, each visual element may require user input in order for a particular enterprise or trading partner to use the resulting process. The start element 402 in an embodiment may further allow or require the user to provide data attributes unique to the user's specific integration process, such as, for example, the source of incoming data to be integrated. For example, the user or the automated data set query suggestion system may use a connector element to define a connection (e.g., an application managing data upon which action is to be taken), and the action to be taken. A user may use a start element 402 to further define a location of such data, according to the language and storage structure understood by the application managing such data. In addition, the data set field value to be accessed according to such a start element 402 in an embodiment may be defined by the user-defined query parameters described directly above. In other embodiments in which such a query is unnecessary in order to identify the targeted data, data set field values to be accessed at the start element 402 may be identified by a data set field name given in a format that adheres to the code language and storage structure used by the application/location/enterprise at which such a data set field value may be accessed. The data set field name to be accessed according to such a start element 402 in an embodiment may also be generated by the automated data set query suggestion system in an embodiment, based on suggested queries that are similar to the user-defined query parameters, as described in greater detail herein. Insertion of the start element 402, or of a connector element 410 in an embodiment may prompt a user to provide user-defined query parameters via the dataset query selection user interface described in greater detail with reference to FIG. 5 to define the connection and location of data inbound from a database, and may suggest similar query parameters to the user.

A map element 406, or TransformMap element in an embodiment may associate a first data set field name for a data set field value being retrieved from a first application or source with a second data set field name under which that data set field value will be stored at a second application or destination. A set properties element 408 in an embodiment may allow the user to set values identifying specific files. A connector element 410 may operate in a similar manner to the start element 402 to define an action to be taken on an identified data set, and may result in prompting the user to provide user-defined query parameters via a graphical interface. Connector elements 410 in an embodiment may differ from start elements 402 in that they do not necessarily occur at the beginning of an integration process. The stop element 412 in an embodiment may operate to terminate the integration process.

The integration application management system in an embodiment may associate each of the visual elements within the integration process-modeling graphical user interface with a set of code instructions written in a machine-readable, executable format. For example, the integration application management system in an embodiment may associate the start element 402 with a connector code set, written in a human-readable, machine-executable code language (e.g., JSON or XML), that includes code instructions for accessing a data set field value associated with a user-specified data set field name defined within the start element 402. In other aspects of an embodiment, the data set field name may be defined within the start element 402 in such an embodiment through execution of a software query, written in a specific query syntax or language (e.g., SQL or NoSQL) by the automated data set query suggestion system. Upon generation and storage within a memory of each of the code sets associated with each of the visual elements within the integration process-modeling graphical user interface 400 in an embodiment, the integration application management system may further generate a runtime engine capable of executing each of these code sets. The integration application management system in an embodiment may transmit the runtime engine and each of the code sets for execution of the integration process modeled by the user via the integration process-modeling graphical user interface for execution of the integration process at a remote location (e.g., behind the firewall of a user's enterprise system/network).

FIG. 5 is a graphical diagram illustrating a dataset query selection user interface for selecting natural language descriptions of previously executed software queries on a user-specified query object according to an embodiment of the present disclosure. The dataset query selection user interface for selecting natural language descriptions in an embodiment may work as part of the integration process-modeling graphical user interface 400 in FIG. 4 to further define elements 402, or 412 in example embodiments. As described herein, a user may provide data attributes unique to the user's specific integration process, such as, for example, the source of incoming data to be integrated, by selecting and customizing “connector” elements such as those described above with reference to FIG. 4. For example, the user may use a start element to define an application managing data upon which action is to be taken, and an action (e.g., create, read, update, delete, get, post) to be taken on data stored there. A user may use a start element to further define which specific data sets such an action should be made by performing a query to locate specific data sets. If the user interacting with the integration process flow modeling user interface described with reference to FIG. 4 chooses to define the specific data sets upon which an action represented by the start element 402 should be executed through such a query approach, for example, the user may be prompted to provide query parameters needed to perform such a query via the dataset query selection user interface 500 illustrated in FIG. 5.

The dataset query selection user interface 500 may allow users to view queries performed by themselves or other users in the past that also involved a user-specified query object, or a user-specified data set source to be queried (e.g., Netsuite™ or SalesForce™) for a current query or search. A user may wish to perform a query similar or identical to one of these previously executed queries, particularly if the previously executed queries displayed are those most often searched or are ranked as most relevant to the one or more query objects specified by a user. In addition to prompting the user to enter the query parameters necessary to identify data sets through a query approach, the dataset query selection user interface 500 may suggest such previously executed and potentially relevant queries for user selection. Further, such a dataset query selection user interface may provide such suggested queries and represent the current user-specified query in natural language that is more easily understood by the user than most searchable database query coding languages (e.g., SQL or NoSQL languages). In such a way, the user may select a natural language, easily understood representation of the user's desired database search. The system for translating software queries into natural language may work in conjunction with the integration application management system to insert code instructions capable of executing such a software query, in the properly formatted query syntax for that database into the full integration process modeled in FIG. 4. As described herein, references made to searchable databases may include query-capable APIs working in combination with corresponding backend applications controlling or managing data sets.

The dataset query selection user interface 500 in an embodiment may include an input field 504 where a user may enter a query object (e.g., “phone number”). As described herein, the query object may define the data set field names across which the query may be performed. For example, setting the query object to “phone number” may result in querying for a user-defined value across data sets having data set field names that include the word “phone number.” The user may enter the user-specified query object (e.g., “phone number”) in an embodiment through use of any known input mechanism, including via keyboard or voice. The query object in an embodiment may correspond to a name of an object identified within JSON code instructions or a data set field name within XML code instructions. An object in JSON defines a data set, and includes a data set field name and a data set field value (e.g., name/value pair). Thus, by providing a query object 504 in an embodiment, a user may identify a word that may be used to search across data set field names. Queries performed pursuant to user input within the dataset query selection user interface 500 in an embodiment may be performed upon remote databases or applications, or via remote APIs, not managed by the service provider server/system. As described in greater detail below, query parameters (e.g., query operator, query object, data set source to be queried) describing each of these queries of remote databases, applications, or APIs may be stored at the previously executed query database managed by the service provider server/system, which may also be separately queried. In order to differentiate these two separate search capabilities, queries performed pursuant to user-specified query parameters (e.g., query object) provided via the dataset query selection user interface 500 may be referred to herein as previously executed or remote queries. Searches of information describing such previously executed or remote queries (e.g., identification of querying user, application queried, query parameters executed therein) may be referred to herein as queries of the previously executed query database.

In some embodiments, the system for translating a software query into natural language may display previously executed and suggested database queries that include the user-specified query object in natural language. For example, upon entering the query object “phone number” in the field 504 in an embodiment, the dataset query selection user interface 500 may provide a drop-down menu 508 displaying a plurality of suggested database queries that include the user-specified query object “phone number” 504. The system of the present embodiments may determine one or more suggested database queries drawn from previously executed database queries based on the received user selected query object. Such suggested natural language representations of database queries may be listed in column 510, and may include, for example, “phone number of customer,” “customer charged in invoice,” “invoice stored in Netsuite™,” and invoice date includes.” Each of these suggested database queries may either contain the query object “phone number,” or may have been identified as a database query or search relevant to other searches on the query object “phone number.” This may occur in some embodiments in which this customer or other customers have previously attempted to locate customer names, invoices, or invoice dates by searching across customer phone numbers.

Determination of relevance for identified, suggested database queries in 510 may be relevant to the database query of the currently modeled integration process based on crowd-sourced histories of previously executed integration processes involving the user-defined query object or even the user-defined query value. Crowd-sourced histories in such an embodiment may include metadata associated with a plurality of customers or users of the dataset query selection user interface 500, or associated user interfaces (e.g., graphical user interfaces described with reference to FIG. 4 above). Such metadata may describe any information input via these graphical user interfaces, and various information describing interaction or behaviors between users and such interfaces, deployments of modeled integration process flows, and executions of modeled integration process flows, as described in greater detail herein. A user in an embodiment may select each of the suggested database queries she would like to include in the current query for setting up a portion of the currently modeled integration process by ticking a box adjacent such a suggestion in column 512. Any number of suggested database queries may be selected in some embodiments and those may be deemed selected, suggested database queries. In other embodiments, other methods known in the art of selecting suggested queries may be used, such as highlighting or clicking on the text of the suggested queries themselves.

At least one of the suggested queries selected in an embodiment may include a query operator. As described herein, a query operator defines a relationship between a query object and a query object value. For example, a query parameter set “customer is John Smith” may include a query object “customer,” a query operator “is” and a query object value “John Smith.” In the example shown with respect to FIG. 5, the suggested query object “invoice date” may be associated at 518 with a user-selected query operator “includes.” Other query operators in embodiments may be, for example, “is,” “is not,” “does not include,” etc. Upon selection by the user of a query suggestion including a query operator 518, or upon direct entry of a query operator by the user, the graphical user interface may prompt the user to choose a query object value to which the query operator applies. For example, in the example sentence “customer is John Smith,” the query operator “is” applies to the query object value “John Smith.” In the example given with respect to FIG. 5, upon selection of the suggested query “invoice date includes,” the dataset query selection user interface in an embodiment may be prompted to provide a value for the query object “date” to which the query operator “includes” applies.

The user may enter a query value within the input field 514 in an embodiment. As described herein, each data set may include a data set field name and a data set field value. For example, a data set describing contact information may include a data set field name “Date” and a data set field value that includes the date “December 2019.” The user in an embodiment may enter a value of “December 2019” at 514 to represent a query parameter set “invoice date includes December 2019.” Such a query may return data sets in which the date for the invoice includes December 2019.

Upon user selection 512 of one or more suggested database queries from column 510 in an embodiment, the dataset query selection user interface may display a single natural language sentence 516 describing multiple suggested database queries as a single, selected suggested database query in natural language. For example, in an embodiment in which the user selects each of the suggested queries shown in column 510, the natural language sentence may be “get phone number of customer charged in Netsuite™ invoice if date includes December 2019.” This may include query objects “phone number,” “customer,” “Netsuite™,” “invoice,” and “date.” This may further include query operator “includes,” and query object value “December 2019.” The combination of these query objects, query operator, and query object value in an embodiment may comprise a query parameter set. As shown, the natural language sentence 516 may also include descriptions of relationships between one or more of these query objects. For example, the natural language sentence 516 may include the phrase “phone number of customer,” describing the fact that the phone number may belong to the customer. In other embodiments, such a relationship may be described, for example, as “phone number for contacting customer,” which may also describe the relationship between the phone number and the customer. As another example, the natural language sentence 516 may include the phrase “customer charged in invoice,” denoting that the query object “invoice” “charges” the query object “customer.” In yet another example, the natural language sentence 516 may include the phrase “invoice stored in Netsuite™,” indicating the query object “invoice” is “stored within” the query object “Netsuite™.” Each of these relationships in an embodiment may be inserted between identified query objects by the automated dataset query suggestion system based on relationships between nodes representing each of these query objects, as stored within a previously executed query database described in greater detail herein with respect to FIG. 7.

Because each of the suggested database queries displayed in column 510, and such a full sentence 516 may be written in natural language, users need not be familiar with any particular query syntax or language in order to craft a query on the user-defined query object. In addition, by viewing the natural language representation of previously executed, suggested database queries, a user may quickly and efficiently increase or narrow the breadth of their current query, without having to translate arcane query syntax into human-readable and understandable concepts. Further, the system for translating a software query into natural language may associate each displayed suggested database or software query in memory with code instructions or query search terms, written in the specific syntax required by the application or API managing the data set field values across which the user is searching.

Upon a user's selection of a suggested search shown in column 510, the integration application management system may generate a code set including the query, written in the proper syntax, and integrate that query within the user's integration process (e.g., an integration process modeled by the visual flowchart described with reference to FIG. 3, above). In such a way, a user not familiar with query search syntax or languages may insert a properly formatted software query across multiple data sets, by selecting a natural language representation of that query via the dataset query selection user interface 500.

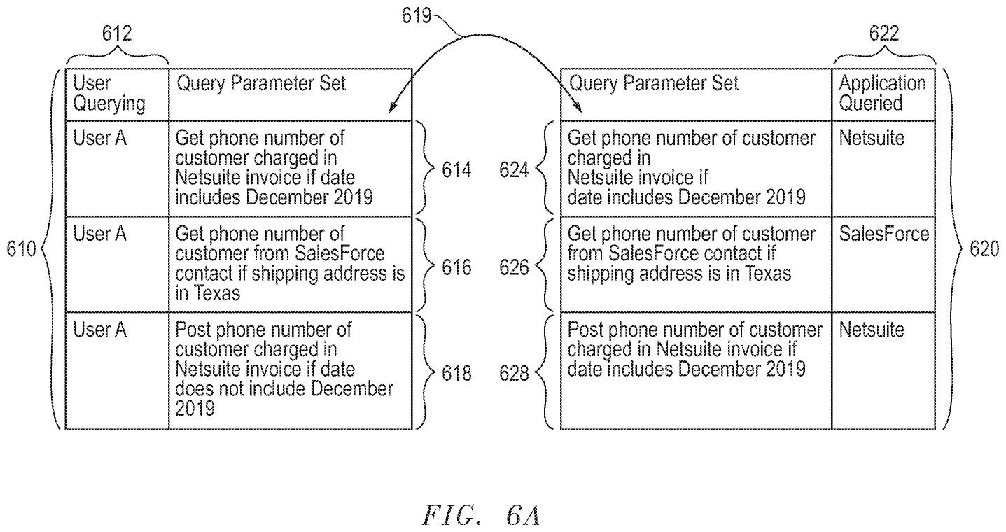

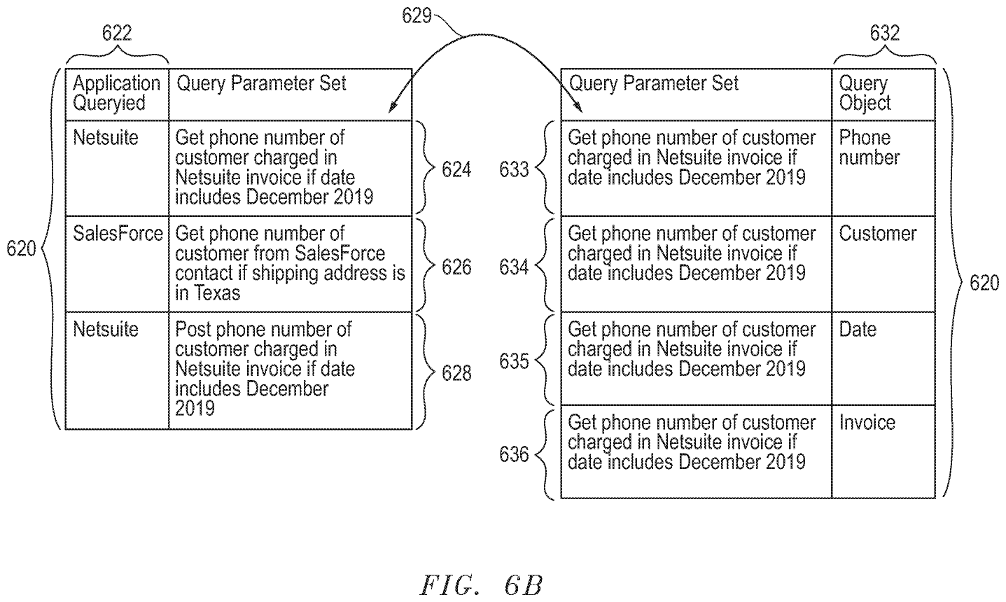

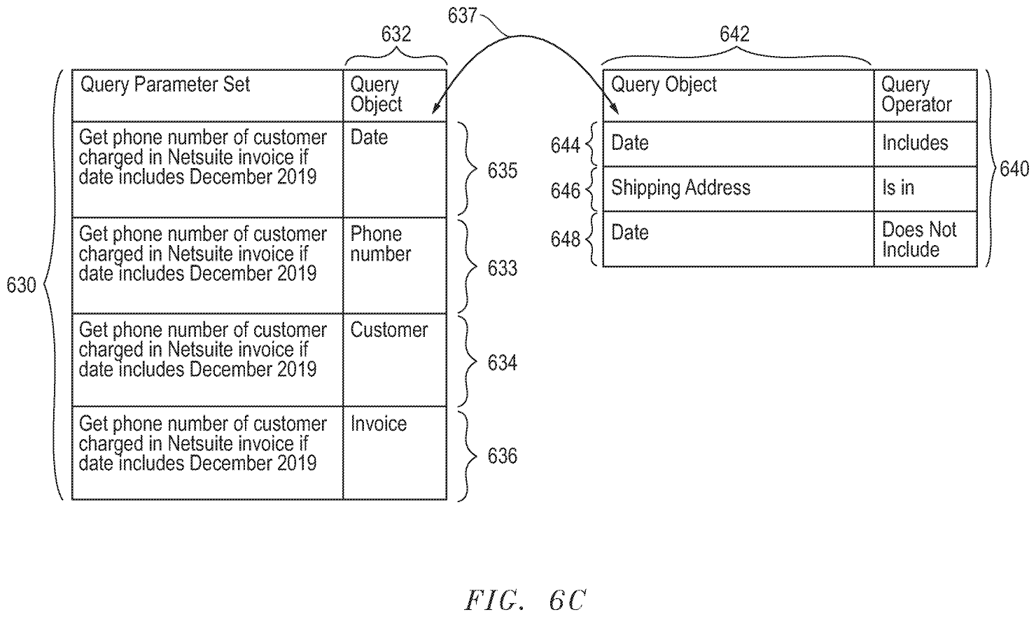

FIG. 6A is a graphical diagram illustrating relational database tables storing identification of users who have previously executed queries of remote APIs or databases according to an embodiment of the present disclosure. As described herein, information describing each query performed pursuant to an executed integration process across multiple clients in an embodiment may be stored in a relational query database for later use in suggesting queries for similar future queries (e.g., future queries including the same query object, query operator, or queried application). These previously executed queries may have been performed to search across remote applications, APIs, or databases, not within the integration application management system, and not managed by the service provider system/server. Such a relational query database in an embodiment may store such information describing each query (e.g., query operators, query objects) previously performed. FIG. 6A depicts an example of such information stored in a relational database according to one embodiment.

The relational query database in an embodiment may store information about previously executed remote queries that may be helpful to the same or other users for future remote queries. For example, a first user, “User A,” may execute a remote query to “get phone numbers for customers charged in Netsuite™ invoices if date includes December 2019.” Such a remote query may include an action “get,” provided by the user via the integration process flow modeling user interface 400 when customizing the start element described with reference to FIG. 4, a set of query parameters, and a conditional phrase beginning with the word “if.” A set of query parameters in an embodiment may include one or more query objects, one or more query operators, and one or more query object values. For example, the set of query parameters for the natural language sentence “get phone numbers for customers charged in Netsuite™ invoices if date includes December 2019” in an embodiment may include the query objects “phone number,” “customer,” “Netsuite™,” “invoice,” and “date,” as well as the query operator “includes,” and the query object value “December 2019,” corresponding to the query object “date.” One of the query objects in an embodiment may also specify the dataset source to be queried (e.g., API, application, or database). For example, the query object “Netsuite™,” in an embodiment may indicate the query should be performed on the Netsuite™ application or using the Netsuite™ API. Such information describing query parameter sets for previously executed queries may be stored within a relational database in an embodiment.

At a later time, User A may wish to perform a second remote query across SalesForce™ contacts for customers' phone numbers if their shipping addresses are in Texas. A user may select query objects for such a second remote query via the dataset query selection user interface described with reference to FIG. 5, for example. As the user enters the query objects “phone numbers,” the automated data set query suggestion system in an embodiment may determine that User A has previously performed a remote query across Netsuite™ invoices for phone numbers for customers purchasing items in December 2019, and may suggest that User A include one or more of the query objects (e.g., “invoices,” “customers,” and “date”) identified in this previously executed search to the current search. In order to make such a determination in an embodiment, the automated data set query suggestion system may perform a query of the previously executed query database (e.g., a query of the information describing previously executed queries stored within the previously executed query database). The previously executed query database in such an embodiment may include some format for storage of data describing previously executed searches. For example, such data may include the user initiating each query, the application queried, the query operator, and one or more query objects.

As described herein, the data set query selection user interface may receive an identification of a user, an application or database to query, and one or more sets of query parameters that may include a query operator, at least one query object and a query value. Such information received via the dataset query selection user interface described with reference to FIG. 5 in an embodiment may be stored in a table-based structure of a relational database, for example, within the previously executed query database. For example, a table 610 may be created for storage of all information related to remote queries, as listed by the user who executed the search. This may be useful for the scenario described directly above, for example, in which the automated data set query suggestion system suggests query objects, for inclusion in a new remote search performed by User A, based on a previously executed remote search, also performed by User A. In other words, the common factor between the previously executed remote search and the currently modeled remote search in such an embodiment may be the fact that User A selected the query parameters for both remote searches. In such a scenario, a table 610 that allows for a search of previously executed remote searches by user may be useful.

The information received via the data set query selection user interface from User A may be stored in table 610, which may include a column 612 and a row 614. Column 612 in an embodiment may include identifications of users who have previously executed remote queries. Row 614 in an embodiment may provide identity of a single user (e.g., “User A”) and the query parameters describing the remote query previously executed by User A. For example, User A may have previously executed a remote query including the query parameter set “get phone numbers for customers charged in Netsuite™ invoices if date includes December 2019.” Because table 610 is designed to store information regarding previously executed remote queries, as organized by the querying user, the querying user may be referred to herein as a primary key for table 610. All information stored within table 610 may be accessed by the automated data set query suggestion system in an embodiment by the system performing a search across the previously executed query database for the querying user, “User A.” In other words, the automated data set query suggestion system in an embodiment may perform a separate query of the previously executed query database for a query object “querying user” having the value “User A.” Such a query may return all information stored in table 610.

More information, pertaining to other searches performed by User A may be added in an embodiment by horizontally scaling the table 610. For example, the table 610 may be horizontally scaled in an embodiment by adding additional rows that describe other previously executed, remote queries performed by User A. More specifically, User A may have performed a second remote query on the SalesForce™ application, rather than the Netsuite™ application. In such an example embodiment, table 610 may be scaled horizontally by adding row 616, describing the queried application as “SalesForce™.” As another example, User A may perform a third query on the Netsuite™ application, using a different query operator than that given in row 614. In such an example embodiment, the table 610 may be scaled horizontally by adding row 618, describing this second query parameter set as including the operator “POST.”

It may be useful to be able to identify information pertaining to query parameter sets directly, regardless of the user who performs the search. For example, several users may have previously performed queries of Netsuite™ applications, within invoices, for customers' phone numbers. In another example, several users may have previously performed queries of Netsuite™ applications, within invoices, for the customers' names alone, without contact information such as phone numbers. In yet another example, several users may have previously performed queries of Netsuite™ applications, within invoices, for different data fields, such as amounts due. In still other embodiments, users may have previously performed one or all of these queries frequently for applications other than Netsuite™, or across data records other than invoices. In each of these scenarios, it may be useful to be able to search previously executed remote queries that have been made within Netsuite™, or within another remote API, application, or database.

Information describing previously executed remote queries, organized according to the source of the dataset queried (e.g., API, application, database) may be stored in table 620, in an example embodiment. For example, table 620 may include a column 622 identifying the API, application (e.g., Netsuite™), or database remotely queried in a previous execution. In such an example embodiment, the remote API, application, or database previously and remotely queried may operate as the primary key for table 620. Each row of table 620 in such an embodiment may include a query parameter set describing the remote query previously executed on the remote API, application, or database described in that row. For example, row 624 may include a query parameter set “get phone numbers for customers charged in Netsuite™ invoices if date includes December 2019.” All information stored within table 620 may be accessed by the automated data set query suggestion system in an embodiment by the system performing a query of the previously executed query database for “Netsuite™.” In other words, the automated data set query suggestion system in an embodiment may perform a query of the previously executed query database for the remote API, application, or database “Netsuite™,” and receive all information stored within table 620, including the previously executed query set parameters “get phone numbers for customers charged in Netsuite™ invoices if date includes December 2019.”

More information, pertaining to other previously executed remote queries made of the same or other remote APIs, applications, or databases may be added in an embodiment by horizontally scaling the table 620. For example, the table 620 may be horizontally scaled in an embodiment by adding row 626, including a query parameter set “get phone numbers for customer from SalesForce™ contact if shipping address is in Texas” describing a previously executed remote query performed within the SalesForce™ application. As another example, the table 620 may be horizontally scaled in an embodiment by adding row 628, including a query parameter set “post phone numbers for customers charged in Netsuite™ invoices if date includes December 2019,” describing a previously executed remote query performed within the Netsuite™ application.

Relational databases may also be vertically scaled by using more than one table to store similar or overlapping information, where each table uses a separate primary key. For example, table 610, using the querying user as the primary key, may include one or more query parameter sets that are identical to query parameter sets stored within table 620, which uses the application remotely queried as the primary key. These identical query parameter sets or overlapping information between tables may be linked, in an embodiment, via a foreign key. For example, the query parameter set “get phone numbers for customers charged in Netsuite™ invoices if date includes December 2019,” in row 614 of table 610 may be linked via foreign key 619 to the identical query parameter set given in row 624 of table 620.

As described herein, the automated data set query suggestion system in an embodiment may perform a query of one or more of these tables within the previously executed query database in order to suggest query parameter sets that may be helpful to a user attempting to model a query of a remote API, application, or database for future execution. For example, User A may provide user input indicating she wishes to model such a remote query for a future execution via the graphical user interface described with reference to FIG. 4, above. In such an example embodiment, the automated data set query suggestion system may query table 610 to determine User A has previously executed a remote query “get phone numbers for customers charged in Netsuite™ invoices if date includes December 2019.” The automated data set query suggestion system in such an example embodiment may display this previously executed remote query parameter set for inclusion within new remote query, for future execution. As another example, a user may provide user input indicating she wishes to model such a remote query of the Netsuite™ application for a future execution via the dataset query selection user interface described with reference to FIG. 5, above. In such an example embodiment, the automated data set query suggestion system may query table 620 to determine users have previously executed remote queries including “get phone numbers for customers charged in Netsuite™ invoices if date includes December 2019.” The automated data set query suggestion system in such an example embodiment may display this previously executed remote query parameter set for inclusion within new remote query, for future execution.

FIG. 6B is a graphical diagram illustrating relational database tables within the previously executed query database storing query objects identified within previously executed query parameter sets and identifications of applications, APIs, or databases previously queried. As described herein, after a first remote query is executed, the same or another user may wish to perform a second remote query using the dataset query selection user interface described with reference to FIG. 5. In an embodiment in which the user wishes to perform a query of phone numbers, the user may enter the query object “phone number,” and the automated data set query suggestion system in an embodiment may determine that a remote query across Netsuite™ invoices for phone numbers for customers purchasing items dated December 2019 has been previously performed. The automated data set query suggestion system in such an embodiment may suggest that the user currently modeling the second remote query include one or more of the query objects (e.g., “invoices,” “customers,” “Netsuite™,” and “date”) identified in this previously executed search to the currently modeled second query.

In order to make such a determination in an embodiment, the automated data set query suggestion system may perform a query of the previously executed query database, which may include some format for storage of data describing previously executed queries, including the user initiating each query, the data set source (e.g., API, application, database) queried, the query operator, and one or more query objects. For example, table 630 may be created for storage of all information related to remote queries, as listed by the query objects included within the previously executed query. This may be useful for the scenario described directly above, for example, in which the automated data set query suggestion system suggests query parameter sets, for inclusion in a second, currently modeled remote search performed by a user, based on a previously executed remote search, in which both queries shared at least one query object in common (e.g., “phone number”). In other words, the common factor between the previously executed remote search and the currently modeled remote search in such an embodiment may be inclusion of the query object “phone number” within both remote queries. In such a scenario, a table 630 that allows for a search of previously executed remote searches by query object may be useful.

The information received via the data set query selection user interface from a user may be stored in table 630, which may include a column 632 and a row 633. Column 632 in an embodiment may include query objects included within previously executed remote queries. Row 633 in an embodiment may provide identification of the query object “phone number,” which may have been included within the previously executed query having the query parameter set “get phone numbers for customers charged in Netsuite™ invoices if date includes December 2019.” Because table 630 is designed to store information regarding previously executed remote queries, as organized by the query objects included, the query object may be referred to herein as a primary key for table 630. All information stored within row 633 of table 630 may be accessed by the automated data set query suggestion system in an embodiment by the system performing a search across the previously executed query database for the querying object, “phone number.”

More information, pertaining to different query objects identified within the same or other previously executed remote queries may be added in an embodiment by horizontally scaling the table 630. For example, the table 630 may be horizontally scaled in an embodiment by adding additional rows that describe other query objects included within the query parameter set “get phone numbers for customers charged in Netsuite™ invoices if date includes December 2019.” More specifically, this query parameter set may also include the query object “customer.” In such an example embodiment, table 630 may be scaled horizontally by adding row 634, describing the query object as “customer.” As another example, this query parameter set may also include the query object “date.” In such an example embodiment, table 630 may be scaled horizontally by adding row 635, describing the query object as “date.” In still another embodiment, this query parameter set may also include the query object “invoice.” In such an example embodiment, table 630 may be scaled horizontally by adding row 636, describing the query object as “invoice.”

As described herein, relational databases may also be vertically scaled by using more than one table to store similar or overlapping information, where each table uses a separate primary key. For example, table 620, using the application remotely queried as the primary key, may include one or more query parameter sets that are identical to query parameter sets stored within table 630, which uses the query objects as the primary key. These identical query parameter sets or overlapping information between tables may be linked, in an embodiment, via a foreign key. For example, the query parameter set “get phone numbers for customers charged in Netsuite™ invoices if date includes December 2019,” in row 624 of table 620 may be linked via foreign key 629 to the identical query parameter set given in row 633 of table 630. Further, because each of the query parameter set given in rows 634, 635, and 636 of table 630 in such an embodiment are also identical to the query parameter set given in row 624 of table 620, each of the cells in the left-hand column of rows 634, 635, and 636 may also be linked to the query parameter set given in row 624 of table 620.

The automated data set query suggestion system in an embodiment may perform a query of one or more of these tables within the previously executed query database in order to suggest query parameter sets that may be helpful to a user attempting to model a query of a remote API, application, or database for future execution, as described herein. For example, a user may provide user input indicating she wishes to model such a remote query for a future execution to include the query object “phone number” via the graphical user interface described with reference to FIG. 5, above. In such an example embodiment, the automated data set query suggestion system may query table 630 to determine that a remote query “get phone numbers for customers charged in Netsuite™ invoices if date includes December 2019” which includes the query object “phone number” has been previously executed. The automated data set query suggestion system in such an example embodiment may display this previously executed remote query parameter set for inclusion within the new remote query that also includes the query object “phone number,” for future execution.

The automated data set query suggestion system in such an example embodiment may also suggest one or more remote APIs, applications, or databases that were queried in previously executed remote queries that included the query object “phone number,” for possible inclusion within the second remote query currently modeled by the user via the dataset query selection user interface (e.g., a GUI described in an embodiment with reference to FIG. 5). In an embodiment, the previously executed query database may include table 620, associating previously executed query parameter sets with a primary key including the API, application, or database queried. The previously executed query database in such an embodiment may also include table 630, associating previously executed query parameter sets with a primary key including query objects included within the previously executed query parameter sets. In such an embodiment, the previously executed query database may not contain a table that directly correlates the API, application, or database queried with query objects identified within a previously executed query parameter set. However, because table 620 and table 630 share overlapping information in the form of previously executed query parameter sets (e.g., “get phone numbers for customers charged in Netsuite™ invoices if date includes December 2019”), the automated data set query suggestion system may determine such a correlation between the application queried and the query object by performing a query across both table 620 and table 630 using a JOIN function.

Relational databases may be queried using a “JOIN” function that allows a querying user to search for such overlapping information across one or more tables. For example, the automated data set query suggestion system may perform join a query of table 630 for query objects having a value “phone number” with a query of table 620 for applications queried using query parameter sets including query objects having a value “phone number.” The result of such a JOIN function in an embodiment may be a determination that previously executed query including the query parameter set “get phone numbers for customers charged in Netsuite™ invoices if date includes December 2019” includes the query object having a value “phone number,” (as found in table 630), and was previously performed by querying Netsuite™ (as found in table 620). The automated data set query suggestion system in such an embodiment may display this previously queried application Netsuite™ (e.g., via the GUI described with reference to FIG. 5) for inclusion within the new remote query that also includes the query object “phone number,” for future execution.

As another example, upon determining the query object “phone number” appears in the query parameter set get phone numbers for customers charged in Netsuite™ invoices if date includes December 2019,” the automated data set query suggestion system may perform an additional query of table 630 for query objects also associated with this query parameter set. The result of such a JOIN function in an embodiment may be a determination that previously executed query including the query parameter set “get phone numbers for customers charged in Netsuite™ invoices if date includes December 2019” includes the query objects “customer,” “date,” and “invoice.” The automated data set query suggestion system in such an embodiment may display these previously included query objects for inclusion within the new remote query that also includes the query object “phone number,” for future execution.

FIG. 6C is a graphical diagram illustrating relational database tables within the previously executed query database storing query operators and query objects identified within previously executed query parameter sets according to an embodiment of the present disclosure. As described herein, after a first remote query is executed, the same or another user may wish to perform a second remote query using the dataset query selection user interface described with reference to FIG. 5. In an embodiment in which the user wishes to perform a query involving customer phone numbers found in invoices from a specific date range, the user may select the query object “date,” and the automated data set query suggestion system in an embodiment may determine that previously executed queries that included the query object “date” used the query operator “includes.” The automated data set query suggestion system in such an embodiment may suggest that the user currently modeling the second remote query include the query operator “includes” to act upon the query object “date,” identified in this previously executed search to the currently modeled second query.

In order to make such a determination in an embodiment, the automated data set query suggestion system may perform a query of the previously executed query database, which may include some format for storage of data describing previously executed queries, including the user initiating each query, the application queried, the query operator, and one or more query objects. For example, table 640 may be created for storage of all information related to remote queries, as listed by the query operator applied to each query object. This may be useful for the scenario described directly above, for example, in which the automated data set query suggestion system suggests query operators to apply to user-selected or provided query objects, for inclusion in a second, currently modeled remote search performed by a user, based on a previously executed remote search, in which both queries shared at least one query object in common (e.g., “date”). In other words, the common factor between the previously executed remote search and the currently modeled remote search in such an embodiment may be inclusion of the query object “date” within both remote queries. In such a scenario, a table 640 that allows for a search of previously executed remote searches by query operator may be useful.

The information received via the data set query selection user interface from a user may be stored in table 640, which may include a column 642 and a row 644. Column 642 in an embodiment may include query objects included within previously executed remote queries. Row 644 in an embodiment may provide identification of the query operator “includes,” which may have been applied to the query object “date” within a previously executed remote query. Because table 640 is designed to store information regarding previously executed remote queries, as organized by the query object included, the query object may be referred to herein as a primary key for table 640. All information stored within row 644 of table 640 may be accessed by the automated data set query suggestion system in an embodiment by the system performing a search across the previously executed query database for the querying object “date.” Such information given within row 644 in an embodiment may be used to generate a natural language clause “date includes,” and to prompt the user to provide a value for the query object “date,” such as “December 2019,” for example.

More information, pertaining to different query operators identified within the same or other previously executed remote queries may be added in an embodiment by horizontally scaling the table 640. For example, the table 640 may be horizontally scaled in an embodiment by adding additional rows that describe other query operators that were applied to the same or other query objects within previously executed remote queries. More specifically, row 646 may indicate the query operator “is in” was previously applied to the query object “shipping address” within a previously executed remote query. Such information given within row 646 in an embodiment may be used to generate a natural language clause “shipping address is in,” and to prompt the user to provide a value for the query object “shipping address,” such as “Texas,” for example. As another example, row 648 may indicate the query operator “does not include” was previously applied to the query object “date” within a previously executed remote query. Such information given within row 648 in an embodiment may be used to generate a natural language clause “date does not include,” and to prompt the user to provide a value for the query object “date,” such as “2018,” for example.

As described herein, relational databases may also be vertically scaled by using more than one table to store similar or overlapping information, where each table uses a separate primary key. For example, table 630, using the query objects as the primary key as the primary key, may include one or more query objects that are identical to query objects stored within table 640, which also uses query objects as the primary key. These identical query objects or overlapping information between tables may be linked, in an embodiment, via a foreign key. For example, the query object “date” in row 635 of table 630 may be linked via foreign key 637 to the identical query object “date” given in row 644 of table 640.

The automated data set query suggestion system in an embodiment may perform a query of both of these tables within the previously executed query database in order to suggest other query objects that may be helpful to a user attempting to model a query that includes specific query objects, as described herein. For example, a user may provide user input indicating she wishes to model such a remote query for a future execution to include the query object “date” via the graphical user interface described with reference to FIG. 5, above. In such an example embodiment, the automated data set query suggestion system may query tables 630 and 640, using a join function to determine that a remote query “get phone numbers for customers charged in Netsuite™ invoices if date includes December 2019” which includes the query object “date” and also includes the query operator “includes” has been previously executed. The automated data set query suggestion system in such an example embodiment may suggest a natural language clause “date includes” representing the query object “date,” and the query operator “includes” for inclusion within the remote query for future execution.

The automated data set query suggestion system in such an example embodiment may also suggest one or more remote APIs, applications, or databases that were queried in previously executed remote queries that included the query operator “phone number,” for possible inclusion within the second remote query currently modeled by the user via the dataset query selection user interface (e.g., a GUI described in an embodiment with reference to FIG. 5). In order to suggest both a query object (e.g., “phone number”) and an API, application, or database to query (e.g., “Netsuite™”), the automated data set query suggestion system in such an embodiment may perform multiple JOIN functions. This may be the case because, as described above with reference to FIG. 6B, the automated data set query suggestion system may perform three separate queries of tables 620, 630, and 640 in order to determine a correlation between query objects, query operators, and APIs, applications or database queried within previously executed remote queries.

The tables shown in FIGS. 6A, 6B, and 6C provide examples of the types of information that may be stored within tables of a relational database. It is contemplated that any type of information describing previously executed remote queries may be stored within tables of a relational database of the previously executed query database in an embodiment. FIGS. 6A, 6B, and 6C are intended to describe the structure of tables within a relational database format for the previously executed query database, and how such tables may be queried to suggest query parameters (e.g., query object, query operator, application to query) in later-modeled remote queries.

Due to the structure of relational databases, which require one primary key for each table, correlations between different data sets (e.g., between query parameter set, query object, query operator, user, or application queried) may be made either by vertically scaling, or by using a greater number of join functions within queries performed across the relational databases. For example, in order to correlate query objects with query operators in the embodiment described with reference to FIG. 6C, a join function may be used, causing a query across two separate tables 630, and 640. As another example, in order to correlate query objects with query operators and application queried, two join functions may be used, causing across three separate tables 620, 630, and 640. Separate searches across a plurality of tables, pursuant to the use of multiple join functions may result in longer total query executions.

As an alternative to multiple join functions, a relational database may be scaled vertically by creating a new table for each correlation that may be made between stored data sets found in other tables. For example, a new table (not shown) including a column describing query objects and a column describing query operators may correlate query objects and query operators that have been included within the same previously executed remote query. The automated data set query suggestion system in an embodiment may then query only this new table in order to identify query operators and query objects that have been used together in previously executed remote queries. As another example, a new table (not shown) including a column describing query objects and a column describing applications queried may correlate query objects and applications queried that have been included within the same previously executed remote query. The automated data set query suggestion system in an embodiment may then query only this new table in order to identify query objects that have been used to query certain applications in previously executed remote queries. This solution requires an ever-increasing amount of storage space for such newly created tables as the correlations or interconnectedness of data sets increases. Thus, neither vertical scaling nor the use of multiple join functions to query relational databases may be optimal solutions to storage of highly interconnected data sets.

In addition, the tables within a relational database in an embodiment may include query parameter sets, queried applications, query operators, and query objects, but may not necessarily include any natural language connectors between them. In other words, the automated data set query suggestion system in an embodiment may use the relational database described herein to identify query operators, query objects, and applications to query, for possible inclusion within a newly modeled remote query for future execution, but such tables may not provide the relationships between these query operators, query objects and queried applications necessary to make such a suggestion in natural language. For example, the automated data set query suggestion system in an embodiment may receive a user instruction to model a new remote query including a query object “phone number,” and may use the tables described herein to determine the application “Netsuite™” is often queried for phone numbers, and that the query objects “date,” “phone invoice,” and “customer” are often included in such queries. However, the tables of the relational database described herein may not provide information sufficient for the automated data set query suggestion system in an embodiment to generate the natural language sentence “get phone numbers for customers charged in Netsuite™ invoices if date includes December 2019.” This may be the case because the tables do not include the connector language “for,” “charged in,” “dated,” or “in,” as shown within this natural language sentence. In some embodiments, a neural network may be employed to identify these proper connectors for insertion between the query parameters (e.g., query operator, query objects).

FIG. 7 is a graphical diagram illustrating a model 700 of information stored in a non-relational database format according to an embodiment of the present disclosure. As described herein, relational databases present certain obstacles to efficient storage and querying of data sets as those data sets become increasingly interrelated or correlated to one another. Non-relational databases may overcome such obstacles by using interrelated nodes, rather than tables to describe relationships between interconnected data sets in an embodiment. Non-relational databases in an embodiment may model multiple nodes, with each node representing the same data sets that may be stored in one or more cells of a table within a relational database. For example, the non-relational database model 700 in an embodiment may include node 702, having a value “Netsuite™,” which correlates to the values within cells 624 and 628 of table 620, as shown in FIGS. 6A and 6B. As another example, the non-relational database model 700 may include node 722, having a value “invoices” correlating to the value within cell 636 of table 630, as shown in FIGS. 6B and 6C. Still further examples, as also shown in FIGS. 6B and 6C include node 752, having a value “customers” correlating to the value within cell 634 to table 630, node 772, having a value “phone numbers” correlating to the value within cell 633 of table 630, and node 732 having a value “date” correlating to the value within cell 635 of table 630. Other nodes within non-relational database model 700 may represent other data sets that may also be stored in tables within a relational database in other embodiments, but which were not specifically described with reference to FIGS. 6A, 6B, and 6C. For example, the non-relational database model 700 in such an embodiment may include node 712 having a value “profit/loss statements,” node 742 having a value “amount due,” and node 762 having a value “shipping address.”

Each node in a non-relational database in an embodiment may be linked to one or more other nodes via an edge that describes the relationship or interconnectedness between the connected nodes. For example, node 702 having a value “Netsuite” may be connected to node 722 having a value “invoices” by a relationship 724 having a value “stores, updates, and deletes.” In such a way, node 702, node 722, and the edge 724 describe the concept that Netsuite™ operates to store, update, and delete invoices. Similarly, node 722 may be connected to node 702 by a relationship 726 having a value “are stored in, and updated or deleted by.” In such a way, node 702, node 722, and the edge 726 describe the concept that invoices can be stored, updated, or deleted by NetSuite™.

As another example, node 722 having a value “invoices” may be connected to node 732 having a value “date” by a relationship 734 value “dated,” or “from.” In such a way, node 722, node 732, and relationship 734 describe the concept that invoices may be dated with a particular date, or may be said to be from a particular date. Similarly, node 732 may be connected to node 722 by a relationship 736 value “of” or “for,” describing the date of a particular invoice or the date for a particular invoice. In another example, node 722 having a value “invoices” may be connected to node 752 having a value “customer” by a relationship 754 value “for,” “sent to,” or “charging.” In such a way, node 722, node 752, and relationship 754 describe the concept that invoices may be for a particular customer, sent to a particular customer, or charge a particular customer. Similarly, node 752 may be connected to node 722 by a relationship 756 value “receiving,” or “charged in” describing the customer that received a particular invoice or the customer that was charged in a particular invoice. In still another example, node 752 having a value “customer” may be connected to node 772 having a value “phone number” by a relationship 774 value “can be contacted at,” or “having.” In such a way, node 752, node 772, and relationship 774 describe the concept that a customer can be contacted at a specific phone number, or a customer has a specific phone number. Similarly, node 772 having a value “phone number” may be connected to node 752 having a value “customer” by a relationship 764 value “for” or “for contacting.” In such a way, node 772, node 752, and relationship 776 describe the concept that a phone number may be for a specific customer, or that a phone number may be for contacting a specific customer.

In a still further example, node 722 having a value “invoices” may be connected to node 742 having a value “amount due” by a relationship 744 value “charging,” to convey that invoices may charge a specific amount due. Similarly, node 742 may be connected to node 722 by a relationship 746 value “charged by” or charged in,” to convey that an amount due was charged by a specific invoice or charged in a specific invoice. In another example, node 752 having a value “customer” may be connected to a node 762 having a value “shipping address” by a relationship 764 value “can be contacted at,” “can receive shipments at,” or “having,” conveying that a customer can be contacted at a specific shipping address, can receive shipments at a specific shipping address, or a customer has a specific shipping address. Similarly, node 762 may be connected to node 752 by a relationship 766 value “for,” “for shipping to,” or “for contacting,” conveying that a shipping address may be for a specific customer, for shipping to a specific customer, or for contacting a specific customer.

Non-relational databases such as the example described in an embodiment with respect to FIG. 7 may be created by the automated data set query suggestion system and stored within the previously executed query database, based on query parameter sets given within code sets of previously executed integration processes. For example, a first user, “User A,” may execute a remote query to “get phone numbers for customers charged in Netsuite™ invoices if date includes December 2019.” Such a remote query may include a queried application “Netsuite™,” query objects “invoices,” “phone numbers,” “customers,” and “date” and a query operator “includes” acting upon the query object “date.” The remote query may also include the query value “December 2019” for the query object “date.” User A may provide such remote query parameters via the dataset query selection user interface described with reference to FIG. 5, for example. In such an embodiment, the automated data set query suggestion system may create a non-relational database model 700, including a node “Netsuite™” 702, a node “invoices” 722, a node “date” 732, a node “customer” 752, and a node “phone number” 772.

The automated data set query suggestion system in such an embodiment may also create relationships between these nodes, based on the previously executed remote query, if such a query was created using natural language. For example, User A may have modeled the previously executed remote query using the dataset query selection user interface described with reference to FIG. 5 in an embodiment by selecting the natural language sentence 516 “get phone numbers for customers charged in Netsuite™ invoices if date includes December 2019.” In such an embodiment, the automated data set query suggestion system may determine that node “phone number” 772 is related to node “customer” 752 by the relationship or edge 776 having a value “for,” based on the use within the natural language query of the word “for” between the identified query objects “phone number” and “customer.” This relationship 776 may convey the fact that the “phone number” 772 is “for” the “customer” 752.

In another example, the automated data set query suggestion system may determine that node “customer” 752 is related to node “invoice” 722 by the relationship or edge 756 having a value “charged in,” based on the use within the natural language query of the phrase “charged in” between the identified query objects “customer” and “invoice.” This relationship 756 may convey the fact that the “customer” 752 was “charged in” the “invoice” 722. In yet another example, the automated data set query suggestion system may determine that node “invoice” 722 is related to node “date” 732 by the relationship or edge 734 having a value “dated,” based on the use within the natural language query of the word “dated” between the identified query object “invoice” and the query object value “December 2019.” This relationship 734 may convey the fact that the “invoice” 722 is “dated” with the value “December 2019” given for the date 732. In still another example, the automated data set query suggestion system may determine that node “invoice” 722 is related to node “Netsuite™” 702 by the relationship or edge 726 having a value “in,” based on the use within the natural language query of the word “in” between the identified query objects “invoices” and Netsuite™. This relationship 726 may convey the fact that the “invoice” 722 is “in” or “stored in” “Netsuite™” 702.

In still other embodiments, the relationships between nodes within non-relational database model 700 may be entered by a person or module other than the automated data set query suggestion system. For example, an IT specialist or neural network module may be employed to determine natural language connectors between nodes created by the automated data set query suggestion system based on previously executed remote searches.

Upon creation of the non-relational database model 700 in an embodiment, the automated data set query suggestion system may reference the non-relational database model 700 in order to suggest new remote queries, for future execution, and in a natural language format. As described herein, the tables within a relational database in an embodiment may include query parameter sets, queried applications, query operators, and query objects, but may not necessarily include any natural language connectors between them. Thus, the tables of the relational database described herein may not provide information sufficient for the automated data set query suggestion system in an embodiment to generate a natural language sentence. In contrast, the relationships between nodes, stored within non-relational database model 700 in an embodiment may provide such connector phrases required to generate a natural language sentence automatically in edges identified between nodes.

For example, the automated data set query suggestion system in an embodiment may receive a user instruction to model a new remote query including a query object “phone number,” via a dataset query selection user interface (e.g., the dataset query selection user interface 500 shown in FIG. 5). The automated data set query suggestion system in such an embodiment may identify that the entered query object “phone number” matches the value for node 772, and may follow each of the relationships connected multiple nodes within non-relational database model 700 to create one or more natural language sentences describing queries including the query object “phone number.” For example, the automated data set query suggestion system in an embodiment may follow the relationship or edge “for” 776 to node “customer” 752 to create the natural language clause “phone number for customer,” and prompt the user to enter a query object value (e.g., name of a customer) for the query object “customer.”

The automated data set query suggestion system in an embodiment may also combine several edges and nodes into a single natural language query based on the interconnections between the nodes in non-relational database model 700. For example, in addition to following the edge 776 to node 752, the automated data set query suggestion system in an embodiment may also follow the relationship “charged in” 756 to node “invoices” 722, relationship “dated” 734 to node “date” 732, and relationship “in” 726 to node “Netsuite™” 702. In such a way, the automated data set query suggestion system may generate the natural language clause “get phone numbers for customers charged in Netsuite™ invoices if date includes . . . ,” and prompt the user to input a query object value (e.g., a date such as December 2019) for the query object “date.”

In another example, in addition to following the edge 776 to node 752, the automated data set query suggestion system in an embodiment may also follow the relationship “shipped to” 764 to node “shipping address” 762. In such a way, the automated data set query suggestion system may generate the natural language clause “get phone number for customer receiving shipment if shipping address includes . . . ” and prompt the user to input a query object value (e.g., Texas) for the query object “shipping address.” In yet another example, in addition to following the edge 776 to node 752, the automated data set query suggestion system in an embodiment may also follow the relationship “charged in” 756 to node “invoices” 722, relationship “charged” 744 to node “amount due” 742, and relationship “in” 726 to node “Netsuite” 702. In such a way, the automated data set query suggestion system may generate the natural language sentence “get phone number for customer charged in invoices from Netsuite™ if amount due is . . . ” and prompt the user to input a query object value (e.g., a dollar amount) for the query object “amount due.” In such a way, the automated data set query suggestion system in an embodiment may generate a natural language representation of suggested queries for inclusion within a new remote query a user is currently modeling via the dataset query selection user interface described with reference to FIG. 5, solely by referencing the nodes and relationships between them within the non-relational database model 700.

In some embodiments, the relationships or edges between nodes may also record the strength of correlation between these nodes. For example, each time a previously executed remote query includes query objects represented by two interconnected nodes in an embodiment, a counter recorded within the edge connecting these two nodes may increment by a value of one. Such a counter may be stored within the previously executed query database as one of the values assigned to the edge. More specifically, the edges 774 and 776 connecting nodes “customer” 752 and “phone number” 772 may include counters. Each time a previously executed remote query including query objects “customer” and “phone number” is received by the automated dataset query suggestion system in such an embodiment, the counters stored within the edges 774 and 776 may be incremented by a value of one. In such a way, the edges between nodes may indicate the frequency with which previously executed remote queries that involved one of these query objects (e.g., “customer”) also involved the other query object (e.g., “phone number”).

FIG. 8 is a flow diagram illustrating a method of identifying query parameter sets within code instructions of a previously executed remote query and storing such parameter sets in a relational or non-relational database according to an embodiment of the present disclosure. As described herein, the automated data set query suggestion system allows users to select commonly used queries appearing in previously executed integration processes for inclusion within an integration process to be executed in the future. FIG. 8 describes the process of parsing, sorting, and storing query parameters describing these previously executed queries.

At block 802 in an embodiment, a runtime engine may execute connector code sets for an integration process at a remote location. For example, in an embodiment described with reference to FIG. 2, the service provider server/system 212 may transmit a runtime engine and code sets for execution of an integration process at an enterprise system 214. Specifically queried data sets may be imported or migrated between locations pursuant to executed connector code set instructions for the integration process in an embodiment. Upon initiation of such a runtime engine, connector code sets, including instructions for performing a remote software query for datasets stored outside the service provider server/system 212 and outside the enterprise network 214 (e.g., at trading partner 208 or 210) meeting specific query parameters may be executed.

These remote software queries may be performed across relational or non-relational databases located remotely from the service provider server/system 212. The remote databases located remotely from the service provider server/system 212 may store the datasets being queried by the connector code sets executed by the runtime engine, and created, read, updated, or deleted pursuant to the integration process being executed. In contrast, the previously executed query database may be located at the service provider server/system 212 and may store terms used in the queries of the remote databases.

The remote databases located outside the service provider server/system 212 in an embodiment may be separate from the previously executed query database, which may also adhere to a relational or a non-relational structure. The structure or formatting of the remote databases may be the same or different than the previously executed query database in an embodiment. For example, the remote database may be relational and the previously executed query database may be non-relational. As another example, the remote database may be non-relational and the previously executed query database may be relational. As yet another example, the remote database and the previously executed query database may both be relational or may both be non-relational.

Executed process metadata may be transmitted to the automated dataset query suggestion system in an embodiment at block 804. For example, in an embodiment described with reference to FIG. 3A, the enterprise system/network 314 where the integration process and remote query were previously executed may transmit executed process metadata 315 to the executed process metadata storage database 321 of the automated dataset query suggestion system 320. The executed process metadata 315 in such an embodiment may describe any query parameters (e.g., query object, query operator, query object value, dataset source queried) applied to a query performed within the previously executed integration process by the enterprise system/network 314, as well as the number of queries performed, and whether such queries were joined with one another. These query parameters in an embodiment may have been performed as part of a search across a remote database located remotely from the service provider server/system.

At block 806, the automated data set query suggestion system in an embodiment may identify query parameter sets given within previously executed code instructions for the integration process. For example, as described in an embodiment with reference to FIG. 3A, the non-relational database-modeling engine 323 of the automated dataset query suggestion system 320 may parse executed query parameter sets 322 received from the executed process metadata storage 321 to identify separate query objects, query operators, and query object values within the executed process metadata 315. Such a parsing may be done by determining the locations of certain words or phrases within known and identified commands recorded within the executed process metadata 315. For example, an XML code instruction for a query may take the form:

| <action> get </action> | |
|---|---|
| SELECT | phone number |
| FROM | ERPPlatform.contacts |
| WHERE | phone number Includes ‘512’ |

Execution of the above code set in an embodiment may return a data set stored at the location “ERPPlatform.contacts” having a field name “phone number” and a field value 512-555-5555 because the data set field value associated with the data set field name “phone number” includes “512.”) ML dictates a standardized method of performing such a query, which defines placement of dataset field names and dataset field values within the code instructions. For example, the text entered following the command “SELECT” may represent the data field name to be queried, which may correlate in an embodiment to a query object. Further, the query operator may follow the identified query object (or dataset field name, e.g., “phone number”) within the line beginning with the command “WHERE.” For example, in the line above, beginning with the command “WHERE,” the identified query object “phone number” is followed by the query operator “includes.” In addition, text following the identified query operator within the line beginning with the command “WHERE” may be identified as a dataset field value, correlating to a query object value. For example, in the line above, beginning with the command “WHERE,” the text “512” following the identified query operator “includes” may be identified as the dataset field value, and also as the query object value associated with the query object “phone number.” JSON formatting may include similar formatting requirements that may be used to identify query objects, query operators, and query object values within JSON code instructions or JSON metadata describing previously executed remote software queries.

Other embodiments of the present disclosure contemplate similar methods of parsing query objects, query operators, and query object values from code instructions or metadata for any currently known or future developed standardized coding language or query language. For example, the code instructions for executing an integration process including a query of a remote, relational database may be written in any currently known, or later-developed structured query language (SQL). As another example, the code instructions for executing an integration process including a query of a remote, non-relational database may be written in any currently known, or later-developed non-structured query language (No-SQL). (e.g., structured (SQL), or non-structured (NoSQL)). The formatting (e.g., relational or non-relational) of the remote database in an embodiment may influence the type of query language used within the code instructions executed to perform the integration process. However, once the query objects, query operators, and query object values have been parsed from the code instructions (or metadata describing such code instructions), these parsed parameters may be used in future queries in any known query language. Thus, once the query parameters have been parsed, they may be stored in a previously executed query database having the same or different formatting as the remote database queried using these parsed parameters. Further, these parsed parameters may be used to generate a future query of another remote database having the same or different formatting as the remote database queried using these parsed parameters.

The automated data set query suggestion system in an embodiment may determine whether executed connector code instructions include a threshold number of JOIN operations within an executed query at block 808. As described in an embodiment with reference to FIG. 3, previously executed query objects (as parsed from the executed query parameters 322 by the non-relational database-modeling engine 323) may be stored in the previously executed query database. As also described in an embodiment with reference to FIG. 6C, due to the structure of relational databases, correlations between different data sets (e.g., between query parameter set, query object, query operator, user, or application queried) may be made either by vertically scaling, or by using a greater number of join functions within queries performed across the relational databases. Queries made across remote, non-relational databases may not require any JOIN functions, which may be applicable only to structured query language (SQL) queries made across relational databases. Thus, in an embodiment in which the code instructions executed by the runtime engine at block 802 perform a query of a non-relational database, the number of JOIN functions may be zero, which may be below any threshold number of JOIN functions, and the method may proceed to block 810 for storage of the parsed query parameters in a relational database format.

The number of JOIN functions used within a query across a relational database in an embodiment may provide a gauge of how interconnected datasets within a queried relational database may be. In other words, the number of JOIN functions may reflect the number of relationships between various tables in the remote, relational database in an embodiment. The number of relationships between search terms used to query these various tables may increase with the number of relationships between the various queried tables themselves. Thus, the number of JOIN functions used within a query across a remote, relational database may provide a gauge of the interconnectedness of the query parameters used (e.g., query object, query parameter, query object value). As described herein, it may be more efficient to store highly interconnected, parsed query parameters in a non-relational format within the previously executed query database.

If the previously executed remote software query code instructions include a number of JOIN functions below a threshold value (e.g., two or fewer), the automated dataset query suggestion system may determine the previously executed remote query parameters should be stored within the previously executed query database in a relational database format, and the method may proceed to block 810. If the previously executed remote software query code instructions include a number of JOIN functions meeting a threshold value (e.g., three, five, ten, or twenty, for example), the automated dataset query suggestion system may determine the previously executed remote query parameters should be stored within the previously executed query database in a non-relational database, and the method may proceed to block 812.

At block 810, the automated dataset query suggestion system in an embodiment may store the previously executed remote query parameters in a table of a relational database within the previously executed query database. For example, in embodiments described with reference to FIGS. 6A, 6B, and 6C, the automated dataset query suggestion system may create tables 610, 620, 630, or 640 for storage of parsed, previously executed remote query parameters (e.g., query object, query operator, dataset queried), or may add such parameters to existing tables 610, 620, 630, or 640. The method may then proceed to block 816 for translation of the previously executed remote query parameters to JSON coding language.

Returning to block 812, in an embodiment in which the executed connector code instructions include a threshold number of JOIN operations within an executed query, the automated data set query suggestion system may determine whether the previously executed query is associated with a non-relational database model. As described in an embodiment with reference to FIG. 7, non-relational databases may overcome obstacles presented by overcomplicated relational databases by using interrelated nodes represented within a non-relational model, rather than tables to describe relationships between interconnected data sets. Non-relational databases in an embodiment may model multiple nodes, with each node representing parsed query objects, and multiple nodes may be connected via edges, with each edge describing a natural language clause representing the relationship between the nodes it connects. Upon parsing of such previously executed remote query parameters, and determination by the automated dataset query suggestion system that such parameters should be stored within a non-relational database, the automated dataset query suggestion system may determine whether such a non-relational database already exists for such storage. A non-relational database may be said to be associated with a previously executed remote query parameter set in an embodiment if the query parameter set includes at least one query object represented by a node within an existing non-relational database model, for example. If the previously executed remote query parameters are not associated with a non-relational database model, the method may proceed to block 814 for creation of a non-relational database model representing the previously executed remote query parameters. If the previously executed remote query parameters are associated with a non-relational database model, the method may proceed to block 818 for addition of nodes to the existing non-relational database, model representing the parsed, previously executed remote query parameters.

At block 814, in an embodiment in which the previously executed query is not associated with a non-relational database model, the automated data set query suggestion system may create a non-relational database model of the previously executed remote query. For example, in an embodiment described with reference to FIG. 7, the automated data set query suggestion system may create non-relational database model 700 and store it within the previously executed query database, based on query parameter sets given within code sets of previously executed integration processes. For example, a first user, “User A,” may execute a remote query including a queried application “Netsuite™,” query objects “invoices,” “phone numbers,” “customers,” and “date” and a query operator “includes” acting upon the query object “date.” In such an embodiment, the automated data set query suggestion system may create a non-relational database model 700, including a node “Netsuite™” 702, a node “invoices” 722, a node “date” 732, a node “customer” 752, and a node “phone number” 772.

The automated data set query suggestion system in such an embodiment may also create relationships between these nodes, based on the previously executed remote query, if such a query was created using natural language. For example, User A may have modeled the previously executed remote query using the natural language sentence “get phone numbers for customers charged in Netsuite™ invoices if date includes December 2019.” In such an embodiment, the automated data set query suggestion system may determine that node “phone number” 772 is related to node “customer” 752 by the relationship or edge 776 having a value “for,” based on the use within the natural language query of the word “for” between the identified query objects “phone number” and “customer.” As described in greater detail with respect to FIG. 7, the automated dataset query suggestion system may perform a similar method to determine natural language relationships between each of the other created nodes. In still other embodiments, the relationships between nodes within model 700 may be entered by a person or module other than the automated data set query suggestion system. For example, an IT specialist or neural network module may be employed to determine natural language connectors between nodes created by the automated data set query suggestion system based on previously executed remote searches.

The automated data set query suggestion system in an embodiment may translate the previously executed query parameter set, as stored in either a relational or non-relational database, to JSON code instructions at block 816. In some embodiments, the executed process metadata describing the previously executed remote query parameters are written in JSON, or the code instructions that were executed to perform the previously executed remote query parameters are written in JSON. In such embodiments, the automated dataset query suggestion system may retrieve and parse the previously executed remote query parameters from the executed process metadata, or the code instructions that were executed to perform the previously executed remote query parameters. For example, in an embodiment described with reference to FIG. 3A, the automated dataset query suggestion system may retrieve such executed process metadata from the executed process metadata storage 321, or receive such parsed portions thereof in the form of executed query parameters 322. In another example embodiment described with reference to FIG. 3B, the automated dataset query suggestion system may retrieve the code instructions that were executed to perform the previously executed remote query parameters by determining the integration process associated with the previously executed remote query parameters within the executed process metadata, then retrieve the code instructions for that integration process from the connector code set database 343.

In other embodiments, the executed process metadata describing the previously executed remote query parameters and the code instructions that were executed to perform the previously executed remote query parameters are written in other coding languages (e.g., XML). In such an embodiment, the automated dataset query suggestion system may build a JSON code set describing the previously executed remote query by inserting the parsed query objects and query operators found within the previously executed query parameters into placeholders for such query objects and query operators within a shell subset of code instructions for performing a remote software query, written in JSON format.

In an embodiment in which the integration process that includes the previously executed remote query is associated with a non-relational database model, the automated data set query suggestion system may add any query parameters added in the most recent execution of the integration process, in the form of nodes or edges, to the non-relational database model associated with that integration process, based on the previously executed query parameter set, at block 818. For example, in an embodiment described with reference to FIG. 7, an existing non-relational database model 700 may include node 722 having a value “invoices” that may be connected to node 742 having a value “amount due” and to a node 752 having a value “customer,” which may be connected to a node 762 having a value “shipping address.” In such an embodiment, the automated dataset query suggestion system may then receive parsed, previously executed query parameters including a queried application “Netsuite™,” query objects “invoices,” “phone numbers,” “customers,” and “date” and a query operator “includes” acting upon the query object “date.” In such an embodiment, the automated data set query suggestion system may add a node “Netsuite™” 702, and a node “date” 732, and connect these nodes 702 and 732 to the existing node “invoice” 722. The automated data set query suggestion system may also add a node “phone number” 772, connected to the node “customer” 752.

The automated data set query suggestion system in such an embodiment may also create relationships between these nodes, based on the previously executed remote query, if such a query was created using natural language. For example, User A may have modeled the previously executed remote query using the natural language sentence “get phone numbers for customers charged in Netsuite™ invoices if date includes December 2019.” In such an embodiment, the automated data set query suggestion system may determine that node “phone number” 772 is related to node “customer” 752 by the relationship or edge 776 having a value “for,” based on the use within the natural language query of the word “for” between the identified query objects “phone number” and “customer.”

Turning to block 820, the query parameters and values for the integration process, as modeled by the non-relational database modeling engine and written in JSON code instructions may be retrieved from metadata associated with the non-relational database model. Some platforms for modeling non-relational databases (e.g., the model 700 shown in FIG. 7) may be capable of generating metadata for a model that includes JSON code instructions for executing a remote software query including the query objects modeled by the nodes of the model. In such an embodiment, the automated dataset query suggestion system may utilize this functionality to generate the JSON code instructions for performing a remote query including two or more query objects represented by nodes of the model.

The integration application management system or the automated data set query suggestion system in an embodiment may store the JSON code instructions drawn from a non-relational database model or from a translation of code instructions from a previously executed remote query within the previously executed query database at block 822. In an embodiment in which the executed process metadata describing the previously executed remote query parameters are written in JSON, or the code instructions that were executed to perform the previously executed remote query parameters are written in JSON, the automated dataset query suggestion system may retrieve such executed process metadata from the executed process metadata storage, or retrieve the code instructions that were executed to perform the previously executed remote query parameters from the connector code set database. In another embodiment, in which the executed process metadata describing the previously executed remote query parameters and the code instructions that were executed to perform the previously executed remote query parameters are written in other coding languages, the automated dataset query suggestion system may build a JSON code set describing the previously executed remote query. The JSON code instructions either built or retrieved by the automated dataset query suggestion system in an embodiment may then be stored within the previously executed query database, and associated within the previously executed query database with each query object or query operator used in such JSON code instructions.

In an embodiment in which the automated dataset query suggestion system uses a platform for modeling non-relational databases via that is capable of generating metadata including JSON code instructions, the automated dataset query suggestion system may store the subset of JSON code instructions within the previously executed query parameters database. The automated dataset query suggestion system in such an embodiment may also associate the subset of JSON code instructions with each of the query objects included within the remote query included within the subset of JSON code instructions.

FIG. 9 is a flow diagram illustrating a method of generating code instructions for remote execution of an application query based on user selection of a natural language sentence describing the query according to an embodiment of the present disclosure. At block 902 in an embodiment, the integration process flow modeling user interface may receive a user instruction to insert or import a connector visual element into an integration process flow chart. For example, in an embodiment described with reference to FIG. 3B, a user may generate a flow diagram in an embodiment by providing a chronology of process-representing integration elements via the use of an integration process-modeling user interface 341, allowing the user to model a full integration process, using one or more visual elements. For example, the elements may include visual, drag-and-drop icons representing specific units of work (known as process components) required as part of the integration process. Such a process component, in an embodiment, may include a user instruction 342 to create a connector visual element, invoking an application-specific connector to access, and/or manipulate data.

The integration process flow modeling user interface in an embodiment may receive a user instruction to perform a user-selected action on an application data set to be identified through an API query at block 904. For example, in an embodiment described with reference to FIG. 3B, adding a connector visual element to the process flow via the integration process-modeling user interface 341 may allow a user to choose from different actions the “connector” component may be capable of taking on a data as it enters that process step in an embodiment. The integration-process modeling user interface 341 may also allow the user to choose the data set or data element upon which the action will be taken. For example, the user instruction 342 to create a connector visual element may include instructions to retrieve a data set stored within a searchable database that meet the parameters of a user-defined search query or a suggested query provided by the automated data set query suggestion system.

At block 906 in an embodiment, another dataset query selection user interface may prompt the user to define the API query parameters. For example, in an embodiment described with reference to FIG. 3B, upon receipt of the user instruction 342 indicating the data set the connector visual element operates on will be identified using a remote software query, the integration process flow modeling user interface 341 may transmit an instruction 343 to the dataset query selection user interface 330 to prompt the user to provide user-selected query parameters 343 for such a remote software query.

The dataset query selection user interface in an embodiment may receive a user-selected query object at block 908. For example, in an embodiment described with reference to FIG. 5, the dataset query selection user interface 500 in an embodiment may include an input field 504 where a user may enter a query object (e.g., “phone number”). As described herein, the query object may define the data set field names across which the query may be performed. For example, setting the query object to “phone number” may result in querying for a user-defined value across data sets having data set field names that include the word “phone number.” In another example embodiment described with reference to FIG. 3B, a user may provide a user-selected query object 331, and a user-selected query object value 332 via the dataset query selection user interface 330. For example, a user may provide a user-selected query object “date,” and a user-selected query object value “December 2019,” via a dataset query selection user interface 330, which may comprise a set of user-specified query parameters. Such a set of user-specified query parameters may further include, in some embodiments, a query operator, such as “includes,” which may be combined with the user-selected query object 331 (e.g., “date”) and user-selected query object value 332 (e.g., “December 2019”) to form a natural language clause “date includes December 2019.”

At block 910, the automated data set query suggestion system in an embodiment may identify previously executed remote queries that have also included the user-selected query object. For example, in an embodiment described with reference to FIG. 3B, the dataset query selection user interface 330 may communicate with the previously executed query database 325 in an embodiment to determine whether other remote queries that include the user-selected query object 331 have been previously executed. The previously executed query database 325 in an embodiment may be a relational database, or a non-relational database, as described herein. The dataset query selection user interface 330 may transmit instructions 333 to search across the previously executed query database 325 for suggested query parameters related to the user-selected query object 331 in the previously executed query database 325.

In an embodiment in which the previously executed query database 325 is a relational database, the automated data set query suggestion system may perform a query across one or more tables to identify query parameters (e.g., query object, query operator, query object value) associated with the user-selected query object 331 within these tables. In an embodiment in which the previously executed query database 325 is a non-relational database, the automated data set query suggestion system may perform a query across a non-relational database model to identify query parameters represented by nodes that are linked to a node that includes the user-selected query object 331 via an edge.

As described with reference to FIG. 7, in some embodiments, the relationships or edges between nodes within a non-relational, previously executed query database may also record the strength of correlation between these nodes. For example, each time a previously executed remote query includes query objects represented by two interconnected nodes in an embodiment, a counter value recorded within the edge connecting these two nodes may increment by a value of one. This counter may thus reflect the number of times a user searching a term, represented by one of the nodes to which the edge connects, also searches the term represented by the other node to which the edge connects. More specifically, the edges 774 and 776 connecting nodes “customer” 752 and “phone number” 772 may include counters. Each time a previously executed remote query including query objects “customer” and “phone number” is received by the automated dataset query suggestion system in such an embodiment, the counters stored within the edges 774 and 776 may be incremented by a value of one. In such a way, the edges between nodes may indicate the frequency with which previously executed remote queries that involved one of these query objects (e.g., “customer”) also involved the other query object (e.g., “phone number”).

In such embodiments, the automated dataset query suggestion system in an embodiment may associate the user-selected query object with a previously executed remote query object represented by nodes within the non-relational database only if the edge connecting the node represented by the user-selected query object to a node representing the previously executed remote query object includes a counter having a value meeting a threshold value. In other words, the automated dataset query suggestion system may only identify previously executed remote query objects as suggested query parameters if previously executed remote queries frequently include both the user-selected query object and the previously executed query object. Such a threshold value may be, for example, ten, one hundred, or one thousand, and may vary based on whether the previously executed queries stored at the previously executed query database have been drawn using a crowd-source method across a plurality of customers, or have been drawn from integration processes executed by a single customer.

In an embodiment in which the automated data set query suggestion system determines a previously executed remote query has also included the user-selected application, or user-selected query object, the automated data set query suggestion system may present other queries associated with the user-selected application and query object for inclusion within the currently modeled remote query at block 912. For example, in an embodiment described with reference to FIG. 3B, previously executed query database 325 may return search results indicating the user-specified query object 331 has been associated with the query objects “phone number,” “customer,” “invoice,” “Netsuite™,” and “date” in previously executed remote queries.

At block 912, the dataset query selection user interface in an embodiment may receive a user selection of a previously executed remote query suggested in a natural language sentence by the automated data set query suggestion system. For example, in an embodiment described with reference to FIG. 7, the automated dataset query suggestion system in an embodiment may combine these previously executed remote query objects into a natural language sentence using the relationships between the nodes representing each of these previously executed remote query objects, represented as edges within the previously executed query database. The automated data set query suggestion system may identify that the entered query object “phone number” matches the value for node 772, and may follow each of the relationships connected multiple nodes within non-relational database model 700 to create one or more natural language sentences describing queries including the query object “phone number.” For example, the automated data set query suggestion system in an embodiment may follow the relationship or edge “for” 776 to node “customer” 752 to create the natural language clause “phone number for customer,” and prompt the user to enter a query object value (e.g., name of a customer) for the query object “customer.”

The automated data set query suggestion system in an embodiment may also combine several edges and nodes into a single natural language query based on the interconnections between the nodes in non-relational database model 700. For example, in addition to following the edge 776 to node 752, the automated data set query suggestion system in an embodiment may also follow the relationship “charged in” 756 to node “invoices” 722, relationship “dated” 734 to node “date” 732, and relationship “in” 726 to node “Netsuite™” 702. In such a way, the automated data set query suggestion system may generate the natural language clause “get phone numbers for customers charged in Netsuite™ invoices if date includes . . . ,” and prompt the user to input a query object value (e.g., a date such as December 2019) for the query object “date.” In such a way, the automated data set query suggestion system in an embodiment may generate a natural language representation of suggested queries for inclusion within a new remote query a user is currently modeling via the dataset query selection user interface described with reference to FIG. 5, solely by referencing the nodes and relationships between them within the non-relational database model 700.

In other embodiments in which the previously executed query database is a relational database, the natural language sentence may be formed by applying a machine-learning method to the suggested query parameters in order to identify conjunctions, verbs, nouns, adverbs, etc., required to form a natural language sentence that includes the suggested query parameters. For example, in an embodiment described with reference to FIG. 3B, the dataset query selection user interface 330 may model the relationships between the suggested query parameters 334, and natural language sentences previously selected by users of the dataset query selection user interface 330 that incorporated these suggested query parameters 334, using a layered neural network topology. Such a neural network in an embodiment may include a plurality of layers, where each layer includes a plurality of nodes representing one of the suggested query parameters 334, the user-selected query object, or the user-selected query object value 332. An output layer to the neural network may include a projected best-fit determination of a natural language sentence that incorporates the suggested query parameters 334, the user-selected query object 331, and the user-selected query object value 332. In other embodiments, such a determination may be made using machine learning, or any artificial intelligence methodologies now known or later developed.

The automated dataset query suggestion system may then transmit the suggested query parameters, in the form of a natural language sentence, for display via the dataset query selection user interface. For example, in an embodiment described with reference to FIG. 3B, the automated dataset query suggestion system in an embodiment may transmit the suggested query parameters 334 to the dataset query selection user interface 330. In another embodiment described with reference to FIG. 5, the dataset query selection user interface 500 may display the full natural language sentence “get phone number of customer charged in Netsuite™ invoice if date includes December 2019” at 516, for selection by the user. A user may then select the natural language sentence for inclusion within an integration currently being modeled via the integration process flow modeling user interface, for later execution at the enterprise system/network.

At block 914, the code set compiling engine in an embodiment may generate connector code sets with machine readable executable code instructions for performing the user-selected action on data sets meeting the API query parameters. For example, in an embodiment described with reference to FIG. 3B, upon user selection of a natural language sentence incorporating one or more previously executed remote query parameters, the dataset query selection user interface 330 may transmit the user-selected, suggested query parameters 335 within the user-selected natural language sentence to the integration process flow modeling user interface 341. The user-selected, suggested query parameters 335 in such an example embodiment may then be incorporated by the integration application management system 340 into the modeled integration process. For example, the connector visual element added to the process flow model via user instruction 342 may describe an action to be performed on a dataset to be identified using the user-selected, suggested query parameters 335.

Once the integration application management system 340 incorporates the user-selected, suggested query parameters 335 within the integration process flow model in an embodiment, the integration process flow modeling user interface 341 may request the JSON code sets associated with the user-selected, suggested query parameters, as stored in the previously executed query database 325. The automated dataset query suggestion system may locate such JSON code sets 336 and transmit them to the connector code set storage 343 of the integration application management system 340. The code set compiling engine 346 may be in communication with the integration process flow modeling user interface in order to determine which code sets to combine together, and in which order, to reflect the integration process modeled via the integration process flow modeling user interface. The code set compiling engine 346 may then retrieve the JSON code sets 336 to combine them with other code sets represented by various other visual elements within the user-modeled integration process flow to create an executable set of code instructions for the full integration process. The code set compilation engine 346 in an embodiment may then compile these combined JSON code instructions into machine-executable code instructions, including a compiled version of connector code set 345.

The integration application management system in an embodiment may create a runtime engine for execution of code instructions for the integration process, including connector code sets at block 916. The integration application management system (e.g., the code set compiling engine 346) operating at least partially at a system provider server/system in an embodiment may generate a dynamic runtime engine for executing these pre-defined subsets of code instructions correlated to each individual process-representing visual element (process component) in a given flow diagram in the order in which they are modeled in the given flow diagram.

At block 918, a network interface device in an embodiment may transmit all connector code sets and runtime engine to an enterprise network for execution at a remote location. For example, in an embodiment described with reference to FIG. 3B, the code set compiling engine 346 in an embodiment may transmit the compiled code set, including a compiled version of connector code set 345, executing the user-selected query parameters, and a runtime engine to the enterprise system/network 314. Upon initiation of such a runtime engine at the enterprise system/network 314 in an embodiment, the connector code set and the remote software query employing the user-selected query parameters may be executed on a remote dataset source (e.g., external application, API, or database not shown in FIG. 3A or 3B).

The blocks of the flow diagrams 8-9 discussed above need not be performed in any given or specified order and may be executed as code instructions at one or a plurality of processors during preparation and set up of a modeled integration process or of a deployed integration process as described herein. It is contemplated that additional blocks, steps, or functions may be added, some blocks, steps or functions may not be performed, blocks, steps, or functions may occur contemporaneously, and blocks, steps or functions from one flow diagram may be performed within another flow diagram. Further, those of skill will understand that additional blocks or steps, or alternative blocks or steps may occur within the flow diagrams discussed for the algorithms above.

Although only a few exemplary embodiments have been described in detail herein, those skilled in the art will readily appreciate that many modifications are possible in the exemplary embodiments without materially departing from the novel teachings and advantages of the embodiments of the present disclosure. Accordingly, all such modifications are intended to be included within the scope of the embodiments of the present disclosure as defined in the following claims. In the claims, means-plus-function clauses are intended to cover the structures described herein as performing the recited function and not only structural equivalents, but also equivalent structures.

The above-disclosed subject matter is to be considered illustrative, and not restrictive, and the appended claims are intended to cover any and all such modifications, enhancements, and other embodiments that fall within the scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. An information handling system operating an automated data set query suggestion system comprising:
a processor executing code instructions to model an integration process for identifying a data set through a remote application program interface (API) query, and performing a user-selected action on the data set;
a dataset query selection user interface (GUI) receiving a user-selected query object;
the processor generating a natural language sentence describing a suggested API query, based on first node value and a first to second edge value for a previously executed query database describing previously executed remote API query parameters;
the suggested API query having suggested query parameters that comprise a suggested query object, a suggested query operator, or a suggested remote API to be queried, associated in the previously executed query database with the user-selected query object;
the GUI receiving a user instruction to perform the suggested API query, described by the natural language sentence, within the integration process;
the processor automatically generating a set of connector code instructions for future execution for performing the user-selection action on the data set matching the suggested query parameters; and
a network interface device transmitting the set of connector code instructions for future execution and a runtime engine for execution at a remote location in deployment of the integration process.

2. The information handling system of claim 1 further comprising:
the processor identifying the previously executed remote API query parameters within a previously executed set of connector code instructions; and
the processor generating the previously executed query database comprising a first node, having the suggested query object as the first node value, connected to a second node, having the user-selected query object as the second node value, via a first to second edge, having the first to second edge value including a natural language relationship between the first node and the second node.

3. The information handling system of claim 2, wherein the previously executed set of connector code instructions are executed by a first user, and the set of connector code instructions for future execution are transmitted to a remote location of a second user.

4. The information handling system of claim 2, wherein the previously executed query database comprises a third node value including an identification of an API to be queried, connected to the first node value via a first to third edge value describing a natural language relationship between the first node value and the third node value.

5. The information handling system of claim 2, wherein the previously executed set of connector code instructions are written in a non-structured query language, and the processor generates the previously executed query database based on metadata describing a previous execution of the previously executed set of connector code instructions.

6. The information handling system of claim 1, wherein the previously executed set of connector code instructions comprises code instructions for a previously executed remote query of a relational database.

7. The information handling system of claim 1, wherein the previously executed set of connector code instructions comprises code instructions for a previously executed remote query of a non-relational database.

8. A method of automatically generating data set query suggestions comprising:
identifying previously executed remote API query parameters, via a processor, including a previously executed query object and a previously queried data set source within a previously executed set of connector code instructions;
generating a previously executed query database comprising a first node value including the previously executed query object, and a second node value, including the previously queried data set source, connected to the first node value via a first to second edge value including a natural language relationship between the first node value and the second node value;
executing code instructions to model a future integration process for identifying a data set managed by a remote data set source to be queried in the future, through a future data set query, via the processor;
receiving, via a dataset query selection user interface (GUI), a user instruction to include the first node value or the second node value within the future data set query;
generating a natural language suggested API query, via the processor, based on the first node value, the second node value, and the first to second edge value;
receiving, via the GUI, a user instruction to perform the natural language suggested API query, within the future data set query;
automatically generating a set of connector code instructions for execution of the future data set query via the processor; and
transmitting, via a network interface device, the set of connector code instructions for future execution and a runtime engine for execution at a remote location in deployment of the integration process.

9. The method of claim 8, wherein the previously executed set of connector code instructions are executed by a first user, and the set of connector code instructions for future execution are transmitted to a remote location of a second user.

10. The method of claim 8, wherein the remote data set source to be queried in the future is a relational database.

11. The method of claim 10, wherein the previously queried data set source is a remotely managed non-relational database.

12. The method of claim 8, wherein the remote data set source to be queried in the future is a non-relational database.

13. The method of claim 12, wherein the previously queried data set source is a remotely managed relational database.

14. The method of claim 8, wherein the remote data set source to be queried in the future is an application programming interface (API).

15. An information handling system operating an automated data set query suggestion system comprising:
a processor identifying previously executed remote API query parameters, including a previously executed query object and a previously queried data set source within a previously executed set of connector code instructions;
the processor generating a previously executed query database comprising:
a first node value including the previously executed query object;
a second node value including the previously queried data set source, connected to the first node value via a first to second edge value including a natural language relationship between the first node value and the second node value;
the processor executing code instructions to model a future integration process for identifying a data set through a future data set query;
a dataset query selection user interface (GUI) receiving a user instruction to include the first node value or the second node value within the future data set query;
the processor generating a natural language suggested API query, based on the first node value, the second node value, and the first to second edge value;
the GUI receiving a user instruction to perform the natural language suggested API query, within the future data set query;
the processor automatically generating a set of connector code instructions for execution of the future data set query; and
a network interface device transmitting the set of connector code instructions for future execution and a runtime engine for execution at a remote location in deployment of the integration process.

16. The information handling system of claim 15, wherein the previously executed set of connector code instructions are executed by a first user, and the set of connector code instructions for future execution are transmitted to a remote location of a second user.

17. The information handling system of claim 15, wherein the previously queried data set source is a remotely managed software application.

18. The information handling system of claim 15, wherein the previously queried data set source is a remotely managed relational database.

19. The information handling system of claim 15, wherein the previously queried data set source is a remotely managed relational database.

20. The information handling system of claim 15, wherein the previously queried data set source is an application programming interface (API).
